(19) United States
(12) Patent Application Publication
(10) Pub. No.: US 2023/0140898 A1
(43) Pub. Date: May 11, 2023

(54) BATTERY FOR USE IN A WATERCRAFT

(71) Applicant: Kai Concepts, LLC, Alameda, CA (US)

(72) Inventors: Donald Lewis Montague, Paia, HI (US); Joseph Andrew Brock, Alameda, CA (US); Tomasz Pawel Bartczak, Toronto (CA); Matthew Campbell Greaves, Oxley (AU); Alec Jon Korver, Alameda, CA (US); Dmitri Stepanov, Alameda, CA (US)

(21) Appl. No.: 17/920,662

(22) PCT Filed: Apr. 22, 2021
(86) PCT No.: PCT/US2021/028716

§ 371 Date: Oct. 21, 2022

Related U.S. Application Data
(60) Provisional application No. 63/079,769, filed on Sep. 17, 2020.
(60) Provisional application No. 63/079,826, filed on Sep. 17, 2020.
(60) Provisional application No. 63/014,014, filed on Apr. 22, 2020.

(51) Int. Cl. B60L 50/60; B63B 32/10; B63H 21/17; B63H 21/21; B60L 15/20; B63B 32/66; H02K 5/132; H02K 11/33; H02K 11/00

(52) U.S. Cl. CPC B60L 50/66; B63B 32/10; B63H 21/17; B63H 21/21; B60L 15/20; B63B 32/66; H02K 5/132; H02K 11/33; H02K 11/0094; B63H 2021/216; B60L 2200/32; H02K 2211/03; H01M 50/213

(57) ABSTRACT

A self-contained battery assembly is provided that is configured to be removably coupled to a watercraft. The battery assembly comprises a waterproof housing including a top portion and a bottom portion that houses a plurality of battery modules. The battery assembly includes a plurality of battery separators manufactured from a material to provide passive protection against thermal event propagation and an electronics module. Each of the battery modules is surrounded on four sides by the one or more of the plurality of battery separators. The plurality of battery separators are disposed within the housing and in physical contact with the top portion and the bottom portion.

### RELATED APPLICATIONS

This application claims the benefit of U.S. Provisional Application No. 63/079,826 filed Sep. 17, 2020 and U.S. Provisional Application No. 63/014,014 filed Apr. 22, 2020, which are incorporated herein by reference in their entirety. The related U.S. application Ser. No. 17/077,784 filed Oct. 22, 2020, now issued as U.S. Pat. No. 10,946,939; U.S. application Ser. No. 17/162,918 filed Jan. 29, 2021; U.S. application Ser. No. 17/077,949 filed Oct. 22, 2020; the application titled “PROPULSION POD FOR AN ELECTRIC WATERCRAFT” filed concurrently herewith on Apr. 22, 2021 as U.S. Application Number TBD; and the application titled “WATERCRAFT DEVICE WITH HYDROFOIL AND ELECTRIC PROPULSION SYSTEM” filed concurrently herewith on Apr. 22, 2021 as U.S. Application Number TBD are incorporated herein by reference in their entirety.

### FIELD

This disclosure relates to rechargeable battery modules and, in particular, to rechargeable battery modules for use in electric hydrofoiling watercraft.

### BACKGROUND

Batteries powering watercraft face extreme conditions, particularly for personal watercraft. Due to the wet environment in which watercraft operate, batteries and associated electronics must be sealed or housed within watertight compartments. Some watercraft may operate in harsh environments, such as shore-break, where typical waterproofing methods are prone to fail. On watercraft such as electric surfboards jet ski devices, the watercraft is exposed to salt spray, shock and vibration, rapid temperature changes and transient electrical loading. These conditions can lead to battery pack failures, which are particularly undesirable for personal watercraft because they could strand the operator of the watercraft. Battery fires are also known to occur in some existing rechargeable battery systems.

Rechargeable batteries currently require a significant charging time, making it desirable to provide a modular battery unit that can be swapped out of the watercraft during charging. The use of modular battery units, however makes it more difficult to provide adequate sealing or watertight compartments, because the battery unit is expected to be removed and replaced frequently.

The challenges described above are especially applicable in electrically powered hydrofoiling watercraft. An example prior art embodiment is illustrated in FIG. 20. Such devices typically include a board 1000 with a watertight compartment (cavity 1020 with cover 1010) that contains electrical components such as electronic motor control components 1022, electrical connectors 1024, and the battery (not shown) that powers the watercraft. Electrical components such as the motor controller 1022 and connectors 1024 within the cavity 1020 of the board are easily accessible to the user, which is undesirable. For example, when inserting the battery into or removing the battery from the board cavity 1020, the user may inadvertently or accidentally move or damage electrical components (1022 and 1024) and cooling lines 1028 housed within the board cavity 1020.

In the known design, the board includes electrical wiring/electrical conduits within the interior body of the board. For example, electrical conduits may be needed within the interior body of the board for transmitting electrical signals between the electronic speed controller components (for example 1022 shown in FIG. 20) and the motor (mounted on a strut below the board). In another example, U.S. application Ser. No. 15/700,658, filed on Sep. 11, 2017 and issued as U.S. Pat. No. 10,597,118 illustrates a design with two wells on a top surface of the board, and a trough for cables running between the two wells.

The known design presents mechanical challenges as well. In the example shown in FIG. 20, the cover 1010 of board cavity must be designed to provide sufficient structural support for supporting weight of rider standing on cover. The board cavity 1020 and cover 1010 are required to be designed to include additional water sealing components/features, for example the thick sealing ring 1026, to prevent water ingress into the board cavity when the cover is in its closed position. This adds weight and complexity to the board design. The battery (not shown) must also be secured within the compartment 1020, for example, using strap 1027 and clip 1025. Both the strap 1027 and clip 1025 are secured to the board, which requires structural reinforcement of the board 1000.

Inserting the battery into or removing the battery from board cavity 1020 necessarily requires the user to open cover 1010, which exposes sensitive electronic components such as the motor controller 1022 housed within the cavity 1020 to undesirable external environmental elements (e.g., while cover is open). These elements could include, for example sand, rain, seawater, etc. Any water able to ingress into the board cavity 1020 may cause a variety of damage to the electronic components housed in the cavity, including, for example, short-circuiting of electrical components, corrosion of electrical components. In view of the problems described above an improved modular battery unit and watercraft system are desirable.

### SUMMARY

Generally speaking and pursuant to these various embodiments, a self-contained battery assembly is provided that is configured to be removably coupled to a watercraft. The battery assembly comprises a waterproof housing including a top portion and a bottom portion that houses a plurality of battery modules. The battery assembly includes a plurality of battery separators manufactured from a material to provide passive protection against thermal event propagation and an electronics module. Each of the battery modules is surrounded on four sides by the one or more of the plurality of battery separators. The plurality of battery separators are disposed within the housing and in physical contact with the top portion and the bottom portion.

In some embodiments, the self-contained battery assembly further comprises a deck pad disposed on an outer surface of the top portion of the housing, such that the self-contained battery assembly is configured to serve as part of a top surface of the watercraft when coupled to the watercraft. In one example, the self-contained battery assembly is configured to serve as part of a top surface of the watercraft when coupled to the watercraft with the battery separators forming a structural element such that the battery module is configured to support an operator of the watercraft.

In some embodiments, the plurality of battery separators includes a plurality of flat sheets forming elongate rectangular separators, with each of the flat sheets having at least one slot such that the plurality of flat sheets slot together to form a lattice. In some embodiments, the self-contained battery assembly further comprises at least one tray with two or more pockets to receive a corresponding two or more of the plurality of battery modules. The at least one tray has a plurality of slots to receive two or more of the plurality of battery separators. The self-contained battery assembly further may include an electrically insulative sheet configured to isolate the tray from an inside surface of the waterproof housing. In some embodiments, the self-contained battery assembly floats in water.

In some embodiments, the self-contained battery assembly further includes a carrying handle pivotally coupled to the housing with at least one arcuate slot formed in the carrying handle. The self-contained battery assembly is configured to be mechanically coupled to the watercraft by engagement of the at least one arcuate slot of the carrying handle with at least one latching pin disposed on the watercraft.

In some embodiments, the self-contained battery assembly further comprises at least one printed circuit board with a plurality of fuses with one or more fuses from the plurality of fuses corresponding to each of the plurality of battery modules. The self-contained battery assembly further comprises an electronics module with first circuitry configured to detect fusing of one or more of the plurality of fuses and second circuitry configured to detect at least one error condition and disconnect the self-contained battery assembly. In some embodiments, the electronics module reports a status of fusing of one or more of the plurality of fuses. In some embodiments, the self-contained battery assembly further comprises a temperature sensor mounted to the at least one printed circuit board, the temperature sensor being configured to monitor a temperature within the housing. In some embodiments, self-contained battery assembly further comprises sensors configured to detect water or humidity inside the housing.

In some embodiments, the electronics module of the self-contained battery assembly contains an inertial measurement unit configured to identify large transient accelerations. In some forms, the inertial measurement unit is configured to remain active when the self-contained battery assembly is not coupled to the watercraft.

An intelligent power unit is provided that is configured to be removably coupled to a watercraft. The intelligent power unit comprises a waterproof housing and a plurality of battery modules disposed within the housing. The intelligent power unit further includes a plug disposed on the housing that is configured to be removably coupled to the watercraft. The intelligent power unit includes an electronic module disposed within the housing. The electronic module includes a wireless transceiver configured to communicate via a protocol selected from the list consisting of Bluetooth, Wi-Fi, and cellular data. The electronic module is configured to report a status data of one or more of the battery modules to a remote location.

In some embodiments, the intelligent power unit further comprises a GPS unit communicatively coupled to the electronic module, the GPS unit being configured to capture a position of the intelligent power unit. The electronic module is configured to report the position of the intelligent power unit with the status data.

In some embodiments, the intelligent power unit comprises at least one accelerometer communicatively coupled to the electronic module. The intelligent power unit further includes drop detection circuitry on the electronic module that is configured to detect large transient accelerations. The electronic module includes a low power mode in which the drop detection circuitry is configured to remain active when the self-contained battery assembly is not coupled to the watercraft.

An intelligent power unit is provided that is configured to be removably coupled to a watercraft. The intelligent power unit includes a waterproof housing and a plurality of battery modules disposed within the housing. The intelligent power unit further includes a plug disposed on the housing that is configured to be removably coupled to the watercraft. The intelligent power unit includes an electronics module that is configured to monitor a digital signal, passive resistance, or capacitance to determine whether the intelligent power unit is connected to the watercraft. The electronics module includes circuitry to disconnect power from one or more pins of the plug of the battery unit upon determining that the intelligent power unit is not connected to the watercraft.

In some embodiments, the intelligent power unit further comprises an inertial measurement unit communicatively coupled to the electronics module, where the inertial measurement unit is configured to determine an orientation of the intelligent power unit. The electronics module is configured to disconnect power to the plug when the orientation is not within a predetermined range of values associated with operational use of the watercraft.

### BRIEF DESCRIPTION OF THE DRAWINGS

FIG. 1 is a top perspective view of an electrically powered hydrofoiling surfboard.

FIG. 2 is an exploded top perspective view of the of an electrically powered hydrofoiling surfboard of FIG. 1.

FIG. 3 is a top perspective view of a container housing battery cells and electronics.

FIG. 4 is a bottom perspective view of a container housing battery cells and electronics.

FIG. 5 is an exploded top perspective view of a container housing battery cells and electronics.

FIG. 6 is an exploded bottom perspective view of a container housing battery cells and electronics.

FIG. 7 is a bottom perspective view of a top portion of a container for housing battery cells and electronics.

FIG. 8 is top perspective view of a bottom portion of a container for housing battery cells and electronics.

FIG. 9A is an exploded bottom perspective view of a container for housing battery cells and electronics.

FIG. 9B is an exploded top perspective view of the container illustrated in FIG. 9A.

FIG. 10 is a cutaway side view, bisecting a container for housing battery cells and electronics along a longitudinal plane.

FIG. 11 is a top perspective view of a cassette including battery cells and associated electronics.

FIG. 12A is an exploded top perspective view of a cassette including battery cells and associated electronics.

FIG. 12B is an exploded front elevation of the cassette illustrated in FIG. 12A.

FIG. 13A is a top perspective view of a tray designed to receive battery cells and associated fuse circuits.

FIG. 13B is a bottom perspective view of the tray illustrated in FIG. 13A.

FIG. 14 is an exploded top perspective view of a cassette including battery cells and associated electronics, omitting the top tray and fuse circuitry.

FIG. 15 is a top plan view of a cassette including battery cells and associated electronics.

FIG. 16 is a block diagram illustrating components included within an intelligent power unit.

FIGS. 17A-D show a side partial cutaway view of a container including a handle used to attach the socket of the container to the plug of the watercraft.

FIGS. 18A-D show a side partial cutaway view of a container including a handle used to remove the socket of the container from the plug of the watercraft.

FIGS. 19A-D show a side partial cutaway view of a container including a handle used to install the socket of the container into the plug of the watercraft.

FIG. 20 is a top rear perspective view of a prior art watercraft having a compartment for housing a battery and electronics.

### DETAILED DESCRIPTION

A modular battery unit disclosed herein provides a watertight container that can be connected and disconnected from a personal watercraft in wet, sandy, muddy, or otherwise harsh environments. The modular battery unit's watertight container is designed to prevent water, humidity, or other environmental contaminants from entering the housing. The modular battery unit may include passive safety features designed to enhance safety of the battery unit when used in harsh conditions. These safety features may include battery separators designed to insulate neighboring cells if a given battery cell experiences a thermal runaway. To reduce the risk of exploding the housing, the housing may include pressure relief regions designed to release high pressure air from the housing away from an operator of the personal watercraft.

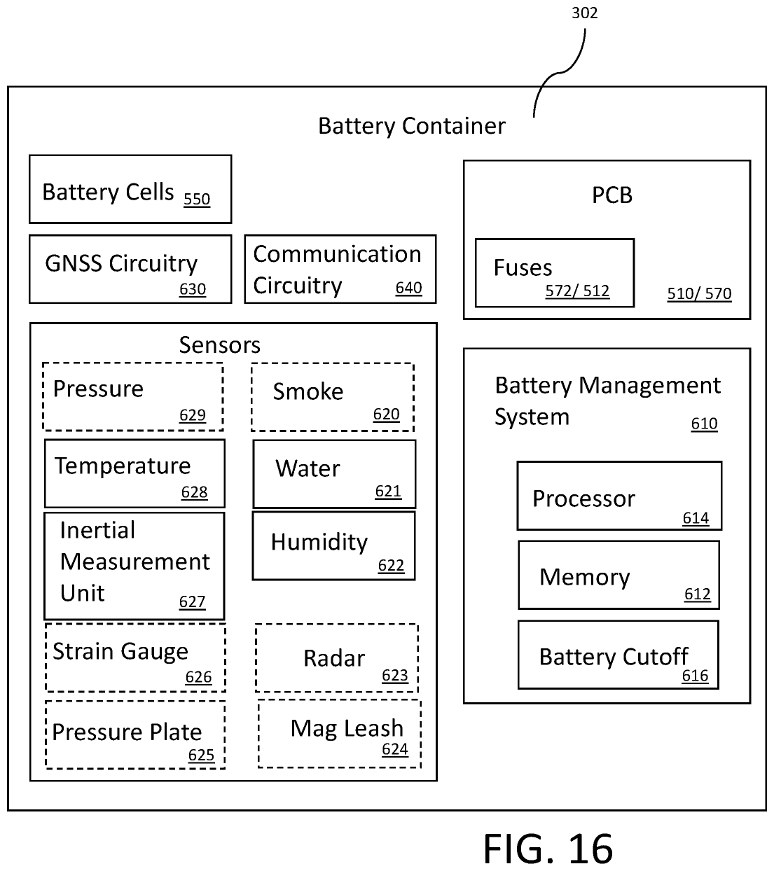

In a preferred embodiment illustrated in the block diagram shown in FIG. 16, the modular battery unit 302 is an intelligent power unit that includes electronics such as processor 614 and memory 612 for managing the battery cells and controlling the watercraft. The intelligent power unit includes active safety systems including an electronically resettable battery cutoff 616 that disables the battery unit in the event one or more of the battery cells malfunctions. The intelligent power unit preferably includes sensors such as a temperature sensor 628, humidity sensor 622, and water sensor 621 to identify undesirable operating conditions within the battery unit. An inertial measurement unit 627 or accelerometers can detect large transient accelerations such as those caused when the intelligent power unit is dropped and strikes a hard surface. Such a drop could damage the watertight housing or the internal components of the intelligent power unit, and therefore is used as a trigger to disable the intelligent power unit using the battery cutoff 616 until the intelligent power unit can be evaluated by a qualified technician. Alternative embodiments may include a pressure sensor to detect a breach of the watertight container 302, as discussed below. Alternative embodiments may include a smoke sensor to detect fire within the container 302, e.g., caused by thermal runaway of a battery cell or other malfunction within the battery unit.

The intelligent power unit may also include sensors to detect the presence of an operator, such as a sensor 624 that detects a magnetic interlock device, which disables the watercraft if the operator falls overboard. Alternative embodiments may detect the operator using a strain gauge 626 on the intelligent power unit, an upward-facing radar 623, or a pressure plate 625. The intelligent power unit may include global navigation satellite system (GNSS) receiver circuitry 630 to determine the position of the watercraft or the intelligent power unit. The intelligent power unit may also include transceivers 640 for sending and receiving data at the watercraft, using known protocols such as Bluetooth, Wi-Fi, or cellular data modems. These and other active safety features of the preferred intelligent power unit are described below.

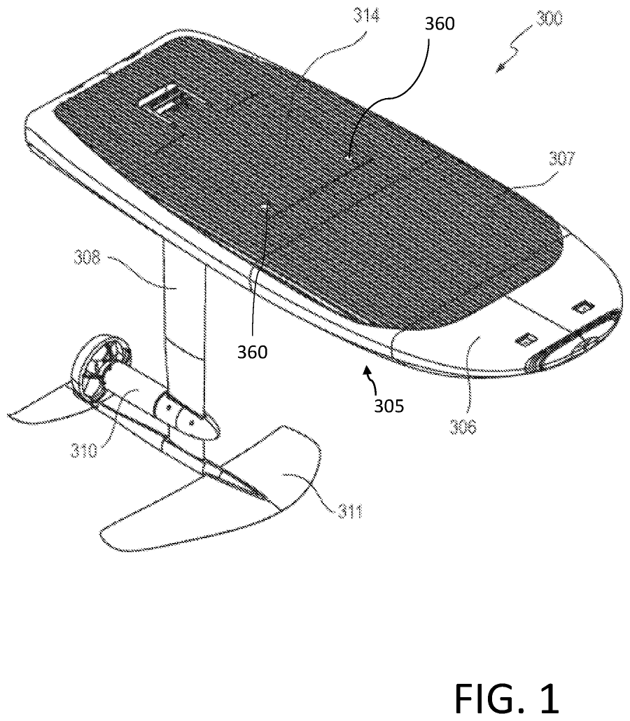

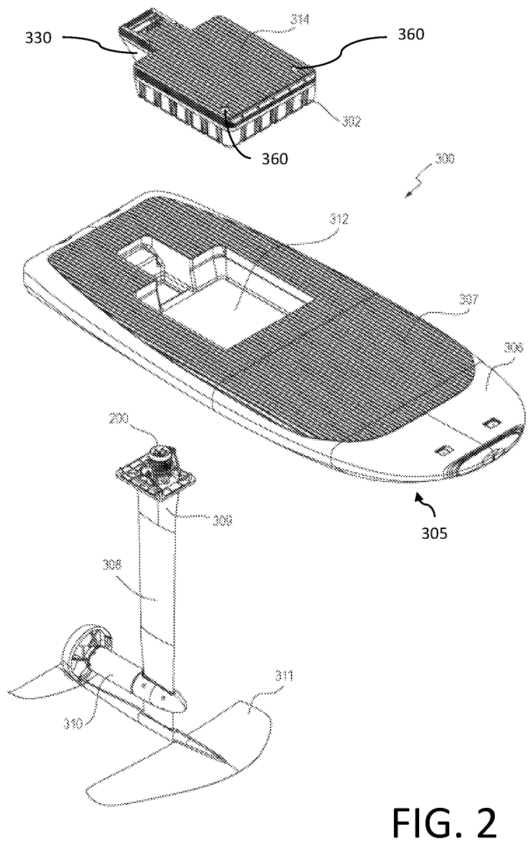

A watercraft 300 is shown in FIGS. 1 and 2, particularly an electrically powered hydrofoiling surfboard device 300 including a board or flotation portion 305, a strut 308, a propulsion unit 310 including an electric motor and propeller attached to the strut 308, and hydrofoils 311 attached to the strut 308. The watercraft 300 is similar in some aspects to the jetfoiler devices described in U.S. Pat. No. 10,597,118 and U.S. patent application Ser. No. 16/543,447, the contents of which are incorporated by reference herein in their entirety. In the illustrated example, the board 305 is made of a material or is sealed such that it has a sufficiently low density that it floats in water or is buoyant. The board 305 may prevent the watercraft 300 from sinking where the other components of the watercraft do not otherwise float. The upper surface of the flotation portion 305 is a deck 306 that may support a rider or user of the watercraft 300. The deck 306 is preferably covered with a deck pad 307, which provides a resilient surface allowing an operator of the watercraft to comfortably sit, kneel, or stand on the deck 306 of the board. In preferred embodiments, the deck pad 307 is an expanded rubber mat adhered to the board 305.

The watercraft illustrated in FIGS. 1 and 2 differs from previously described electric hydrofoiling surfboards such as the jetfoiler device. As described above, prior devices utilized a water-tight compartment to enclose batteries and other sensitive electronics. In contrast, the watercraft 300 includes an open cavity 312 within the flotation portion 305 sized to receive container 302. In the illustrated device, the upper surface 314 of the container 302 forms a portion of the deck 306 of the watercraft 300 when inserted into the cavity 312. For example, the upper surface 314 of the container 302 is substantially coplanar with the top surface or deck 306 of the flotation portion 305, such that the top surface of the container 302 effectively forms a part of the deck 306 or the top surface of the flotation portion. A person standing on the deck 306 should notice little difference between the upper surface 314 of the container 302 and the deck 306 of the flotation portion 305 when, for example, their foot is partially on the deck 306 of the flotation portion 305 and partially on the upper surface 314 surface of the container 302. In preferred embodiments, the upper surface 314 of the container 302 is covered with deck pad 307 to match the remainder of the deck 306.

The design of the watercraft 300 benefits in several aspects from the design of the container 302. The strut 308 is designed, for example to allow water into an internal cavity of the strut where electrical wires are located. This “wet strut” concept is beneficial for battery cooling, because it uses power wires running to the motor 310 to conduct heat away from battery. The electrical wires in strut (connected to the container 302) can be used to conduct internal heat from the battery away from the container, and the wires are cooled by the surrounding water (e.g., ocean water). In preferred embodiments, the electrical wires are insulated with PTFE (teflon) rather than rubber insulating materials. The use of PTFE reduces an outer diameter of the cable jacket to provide better heat transfer. Using PTFE, a cable jacket thickness can be less than 1 mm, whereas conventional jacket materials are typically 2× thicker (or more). In addition, PTFE has a higher melting point that rubber insulating materials that are typically used.

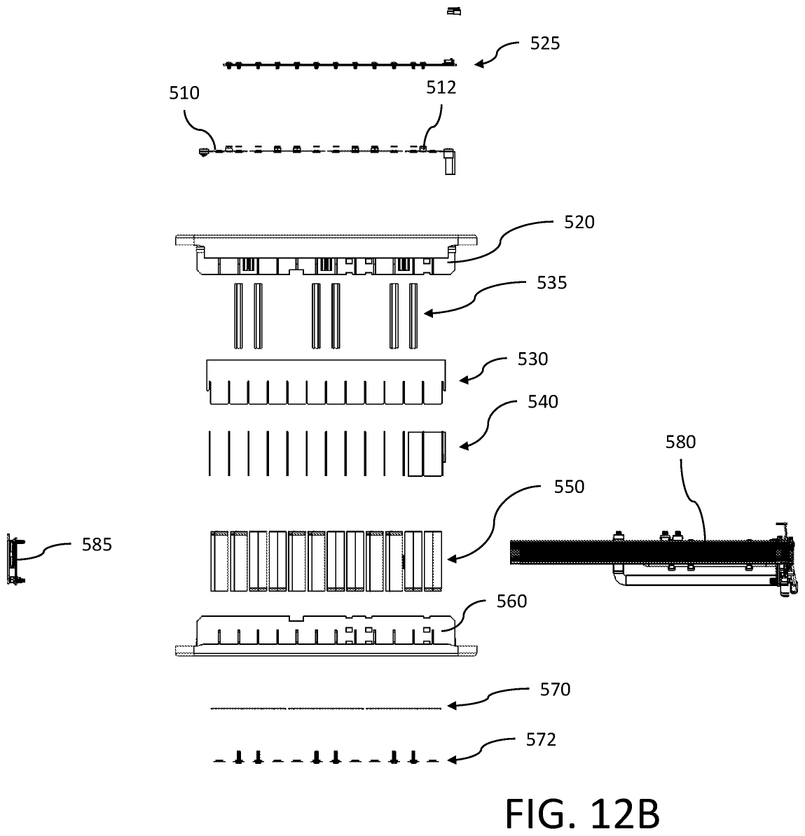

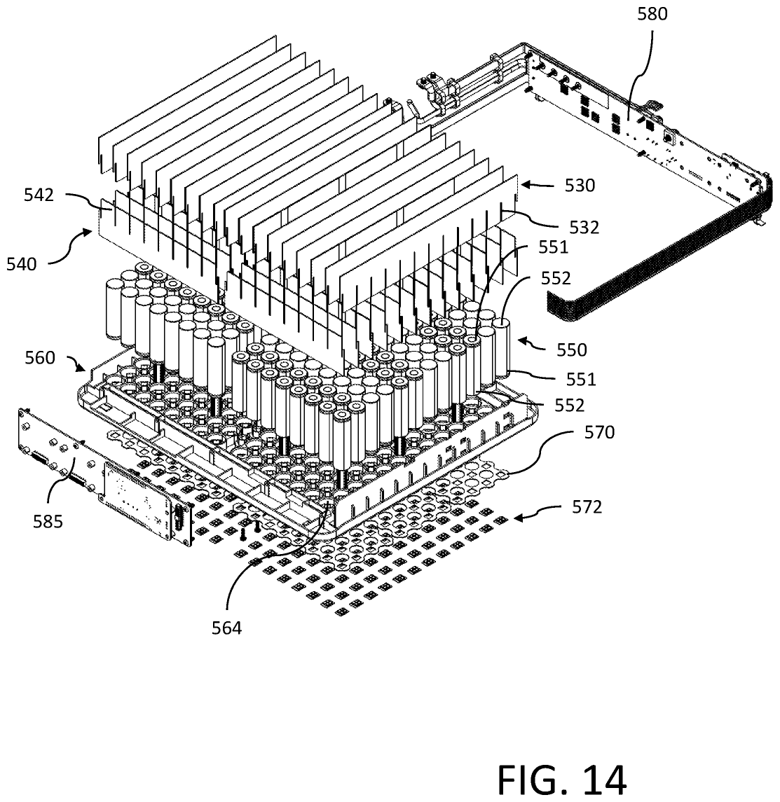

The container 302 is designed to be watertight and may be formed of a resilient and tough material, such as a plastic or carbon composite to support a rider. Because the battery unit 302 generates heat when the enclosed battery cells 550 (illustrated in FIGS. 12 and 14) charge or discharge, the container 302 is preferably designed with heat transfer surfaces (not shown) to conduct heat away from the battery cells. Because the container 302 is watertight, it is preferably designed with a rupture disc and tortuous exhaust pathway (not shown), allowing pressure to dissipate safely from the container 302 in the event of a temperature increase caused by thermal runaway within the battery cells 550. For example, a weak spot or rupture plate in the top housing portion 370 or bottom housing portion 380 can deliberately rupture in the event of an internal battery malfunction or thermal runaway, directing any expelled material away from an operator of the watercraft 300. In alternative embodiments Gore vents may be used in addition to the rupture plates to dissipate pressure without compromising watertightness of the container 302.

The disclosed design thus advantageously eliminates the need for a separate watertight compartment. In the illustrated device 300, the container 302 is rigidly coupled to a strut 308. This approach avoids several engineering challenges present in prior devices, where batteries were stowed in a water-tight compartment and electrically connected to a motor affixed to the strut via flexible cables running through the board. The present design advantageously eliminates the need for a cable harness within the board 305 and therefore simplifies manufacture of the board. Instead of running through cables within the board 305, electrical power from a battery or other power source and communication signals from a transceiver are transmitted directly from the container 302 through the socket 100 to the plug 200 and through wires within the strut 308. A motor and transceiver in the propulsion unit 310 receives the necessary electrical power and communication signals.

In addition, the disclosed design reduces the need for structural components and mechanical connections integrated within the board 305, which simplifies manufacture of the board. Prior devices required substantial layup around structural elements such that a board could connect first to the strut and second to form a watertight compartment for a battery. In the design illustrated in FIGS. 1 and 2, the flotation portion 305 is sandwiched between the upper portion 309 of the strut 308 and the container 302. This distributes stress throughout a larger area of the board and therefore reduces the need for carbon fiber or fiberglass layup to incorporate metallic or other rigid structural members within the board. Further, the disclosed design reduces the need for close dimensional tolerances in the board 305. The illustrated design is also advantageous for disassembly and transport of the watercraft 300. For transport of the device 300, detaching the strut 308 from the board 305 is desirable. Many quick-release designs, however, require incorporating tight dimensional tolerances in the board. In the disclosed design, the container 302 is quickly and securely connected directly to the rigid structures of the strut 308, which may compress the board 305 to form a tight connection between the strut 308, the container 302, and the board 305.

Although not illustrated, other embodiments incorporate a cavity in a bottom surface or rear surface of the flotation portion 305. Although these bottom or rear loading embodiments beneficially reduce the need for a cable harness within the flotation portion 305, they do not necessarily provide the structural advantages described above. Other aspects of the illustrated watercraft 300 remain substantially the same, specifically including the manner in which the connector 50 directly connects the container 302 to the strut 308. Preferably in these embodiments, an outside surface of the container is substantially coplanar with the outside surface of the flotation portion 305, which additionally serves to reduce complexity in the flotation portion 305 by eliminating the need for a compartment door hatch.

The watercraft may also be a boat, an electric surfboard, a jet ski, or any device for use on the water that includes a battery and/or other electrical equipment, with similar benefits. While the example application above shows the container 302 within the deck 307 of the hydrofoiling device, the container 302 may similarly be inserted into the deck of another watercraft 300, for example, a boat. In other examples, the container 302 similarly attaches to another surface of the watercraft 300, for example, the upper surface 302 forms a portion of an internal wall or the exterior surface of the watercraft (e.g., a jetski). In some embodiments, the upper surface 314 is not planar but matches the contour of the surface to which it is attached. For example, where the container 302 is attached to a cavity in a curved surface, the upper surface 314 of the container 302 may match the curvature of the curved surface, such that the presence of the container 302 is discrete.

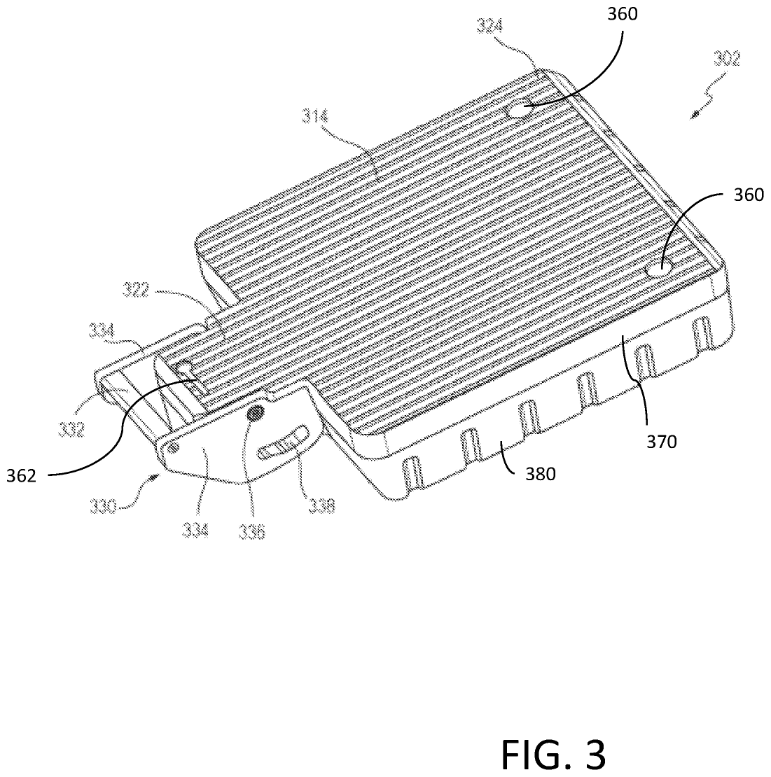

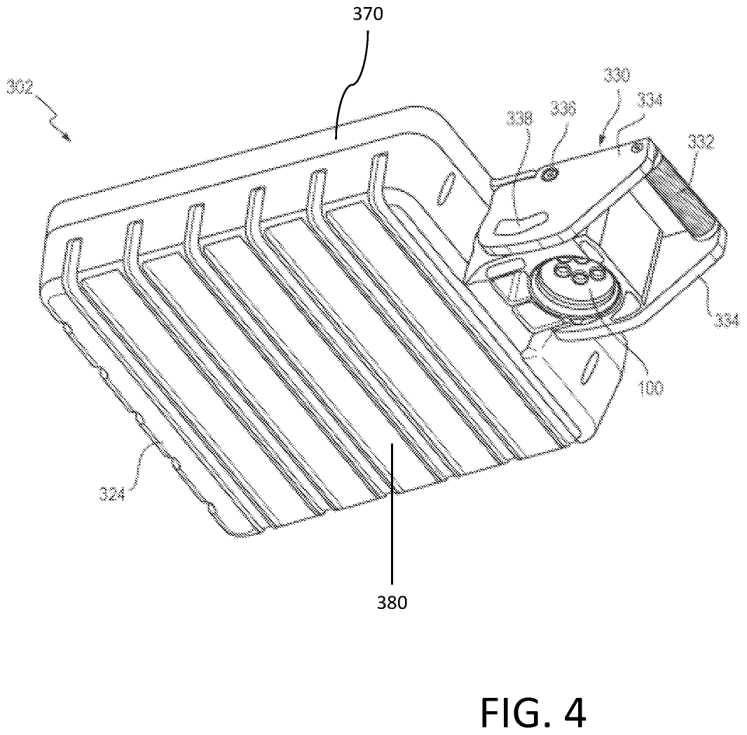

FIGS. 3-4 provide external views of the container 302. The container 302 is a watertight container that may house a rechargeable battery and associated safety features. In the embodiment shown, a socket 100 is located within an end 322 of the container 302. A corresponding plug 200 is attached to the upper end 309 of the strut 308, as illustrated in FIG. 2. The contact pins within the plug 200 are electrically coupled to an electric motor (e.g., of the propulsion unit 310) and an electronic speed controller attached to the strut 308. The contact pins of the plug 200 are configured to contact the pin connectors of the socket 100 when the plug 200 is inserted into the socket 100 of the container 302. The pin connectors of the socket 100 are electrically coupled to the battery and electronics housed within the container 302. The components of the socket 100 and plug 200 are discussed in detail in U.S. patent application Ser. No. 17/077,784, filed on Oct. 22, 2020, and now issued as U.S. Pat. No. 10,946,939, which is hereby incorporated by reference in its entirety.

In use, the container 302 may be positioned within the cavity 312 of the watercraft such that the socket 100 receives the plug 200. This provides one or more electrical pathways between the container 302 and the strut 308. An electrical pathway may extend from the battery within the container 302 to the electric motor of the propulsion unit 310 attached to the strut 308. Another electrical pathway may extend between the transceiver of the container 302 and a transceiver associated with an electronic speed controller attached to or enclosed within the strut 308. In one form, the plug 200 is attached via holes 280 such that the plug 200 may pivot slightly to aid in inserting the plug 200 into the socket 100. When the battery of the container 302 needs to be removed (e.g., to be recharged or replaced) the container 302 is removed from the cavity 312 of the watercraft 300, disconnecting the socket 100 from the plug 100. Because both the socket 100 and the plug 200 include seals to prevent fluid from passing through the socket 100 or plug 200 even when the plug 200 is not inserted into the socket 100, the container 302 may be removed even in wet environments, for example, when the watercraft 300 is still within the water.

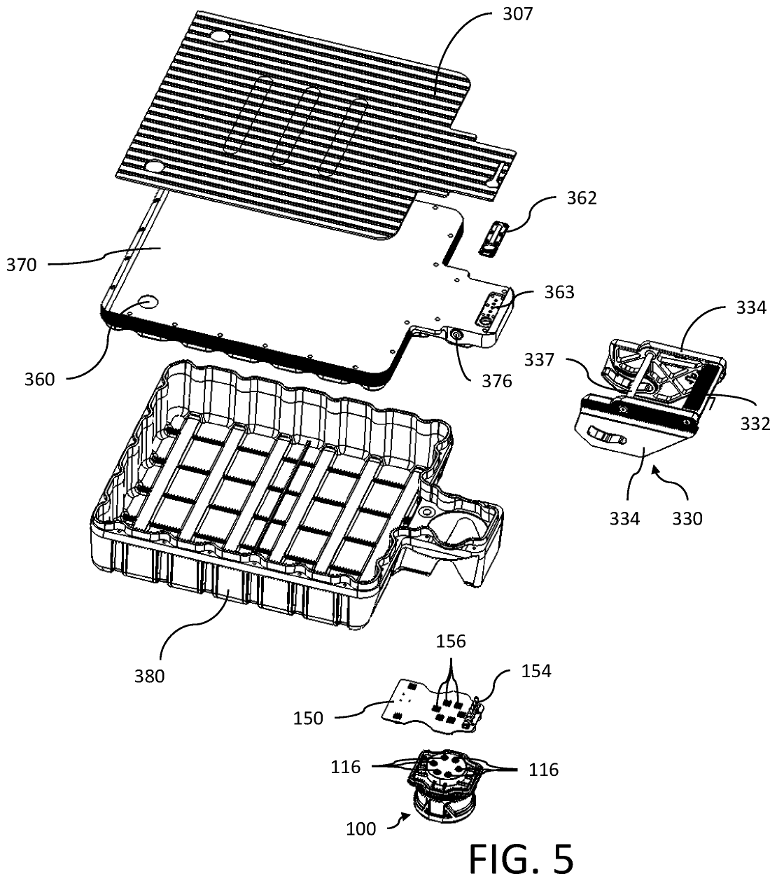

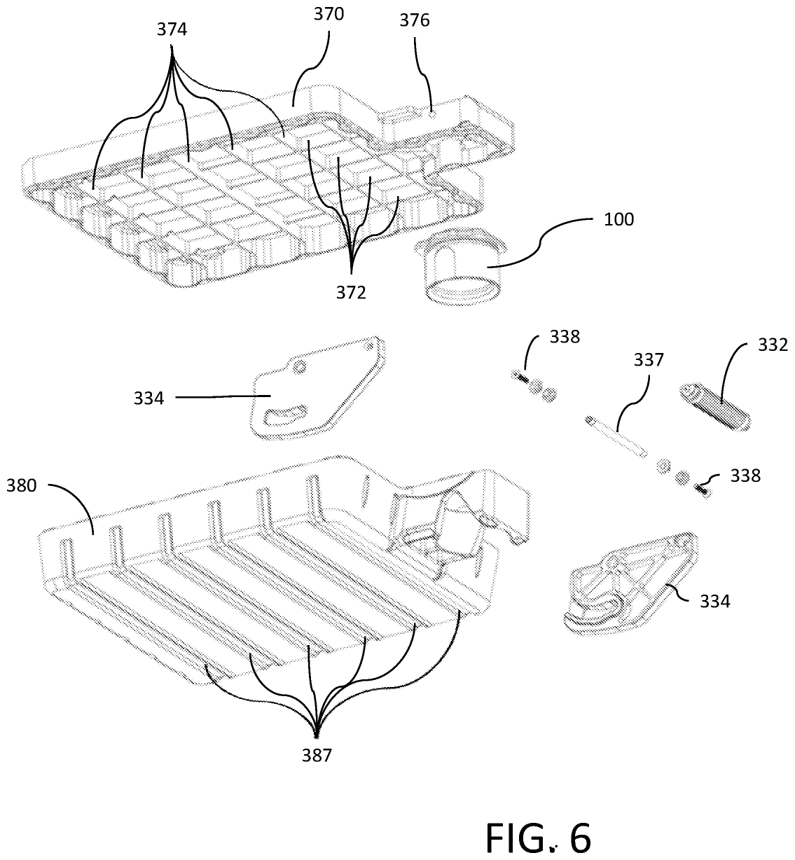

FIGS. 5 and 6 illustrates external components of the container 302 in the preferred embodiment, including bottom housing portion 380 and top housing portion 370. The container 302 includes user interface features, including a battery charge indicator 362, mounted within a battery indicator cavity adjacent to the handle 330. In the preferred embodiment, the battery charge indicator 362 includes a row of LED lights 154 mounted on a connector circuit board 150. When all lights 154 are lit the indicator 362 communicates to the operator that the battery is fully charged. As charge in the battery depletes, an increasing number of the lights 154 will turn off. In some examples, the lights 154 flash or light with different colors to indicate low charge.

Magnetic connection points 360 retain a magnetic interlock key. A sensor is located within the container beneath the magnetic connection point to detect presence of a magnetic interlock key that is configured to be attached via a tether to the operator while riding the watercraft. If the operator falls off the watercraft, the tether pulls the magnetic interlock key free from the magnetic connection point, causing circuitry in the container 302 to disable the watercraft.

A pivoting handle 330 allows the operator to remove the container 302 from the watercraft. The bar 337 is assembled into the hole 376 in the top housing portion 370. The bar 337 provides the pivot axis for the handle 330. Both the bar 337 and the handle grip 332 are attached to side panels 334 using fasteners such as the screws and washers 338 (shown in FIG. 6). By pulling on the handle grip 332, the operator rotates the handle upwards and disengages the container 302 from the watercraft. Operation of the handle 330 is described in greater detail below.

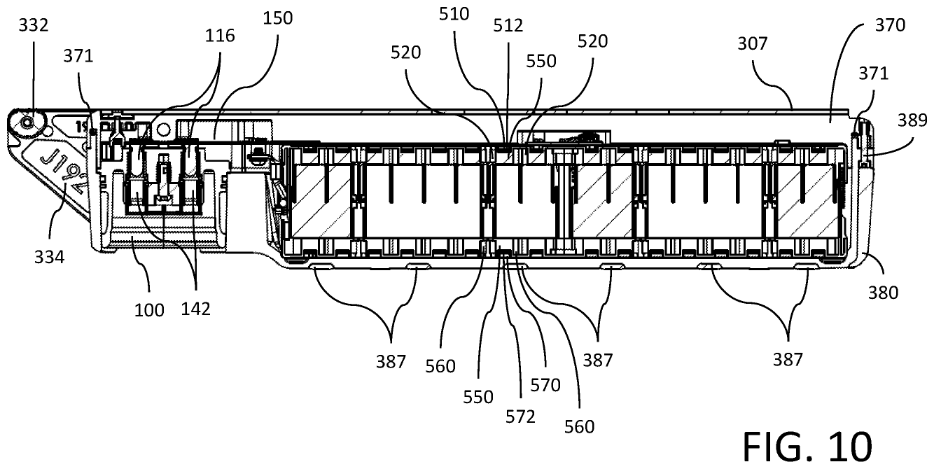

The socket 100 includes pins 116 that are soldered to pads (e.g., 156) in the connector circuit board 150. The pins 116 are fixed within the socket, as discussed in U.S. patent application Ser. No. 17/077,784. Separate external pins (142 in FIG. 10) receive plug pins when the container 302 is affixed to the watercraft 300. The socket 100 mounts within the bottom housing portion 380 and forms a watertight seal between the socket 100 and the lower housing portion 380.

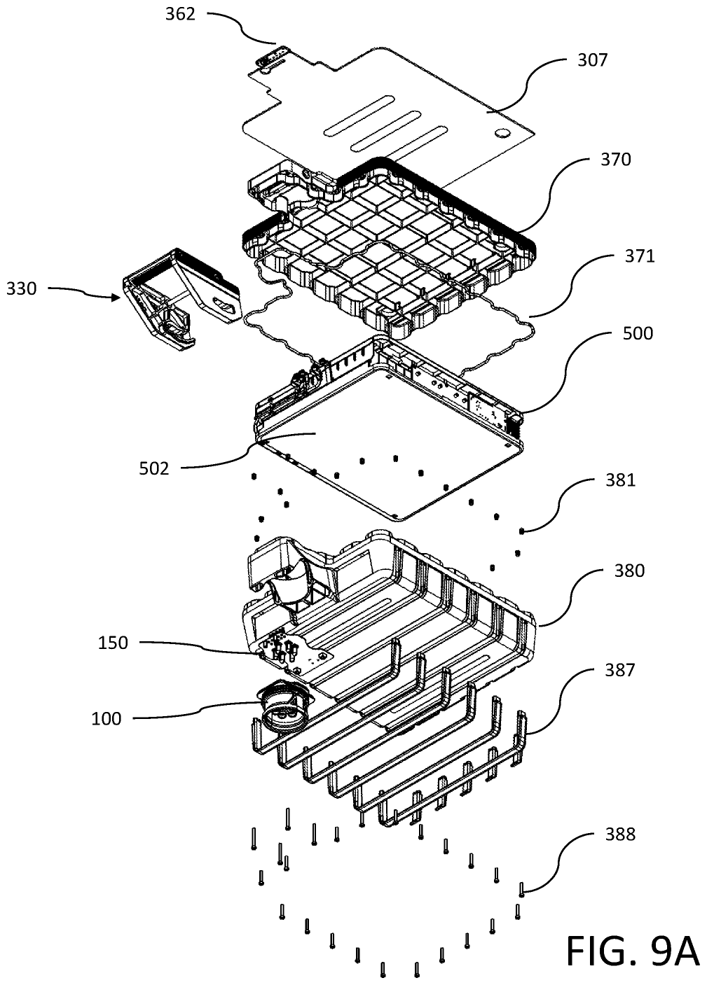

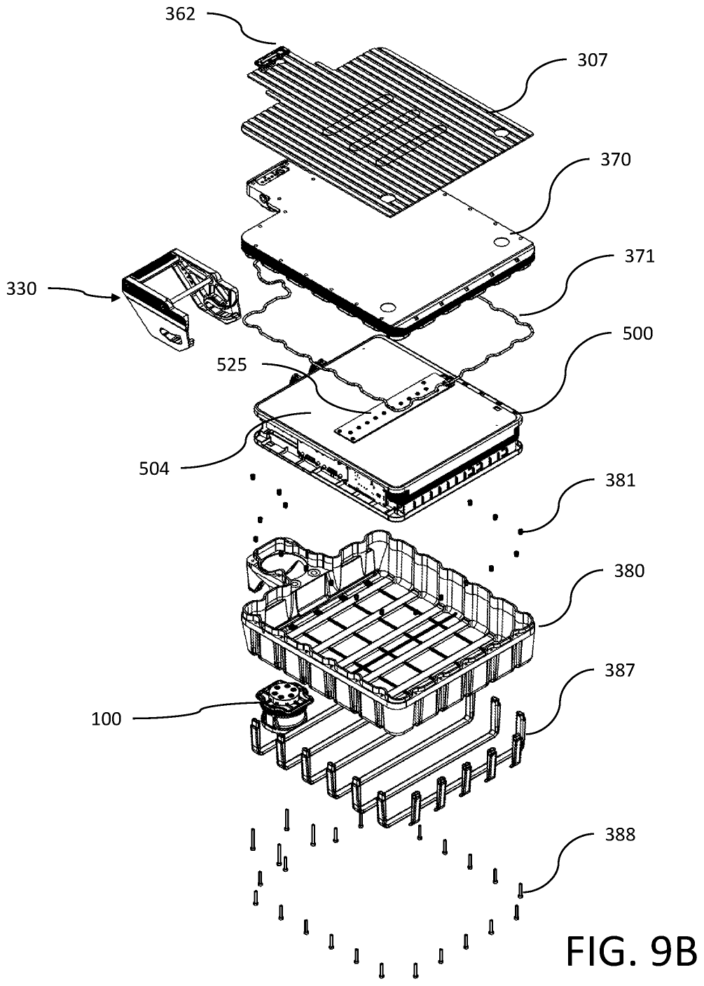

FIG. 6 illustrates additional features of the container 302. The top housing portion 370 includes a series of transverse ridges 374 and longitudinal ridges 372. These ridges allow the external surface (i.e., top 314) of the container 302 to support heavy weight, for example operators up to 300 lbs. standing on top of the container 302 while riding the watercraft 300. The longitudinal ridges 372 and transverse ridges 374 transfer weight to the battery cassette 500 (shown in FIG. 9) and more specifically to the vertical fire suppressors barriers 530 and 540 (shown in FIGS. 12 and 14), providing even distribution of weight. In this way, the container 302 is a structural battery box, capable of supporting loads applied to the deck 306 of the watercraft 300.

The bottom housing portion 380 includes a series of channels 381 configured to receive isolation strips 387 (shown in FIG. 9). In the preferred embodiment, the isolation strips 387 are rubber, selected to dampen and isolate vibration between the flotation portion 305 and the container 302. The isolation strips 387 are designed to act as dampers for the mass at the top of the strut 308, in addition to protection of the battery components and protection of the board cavity 312.

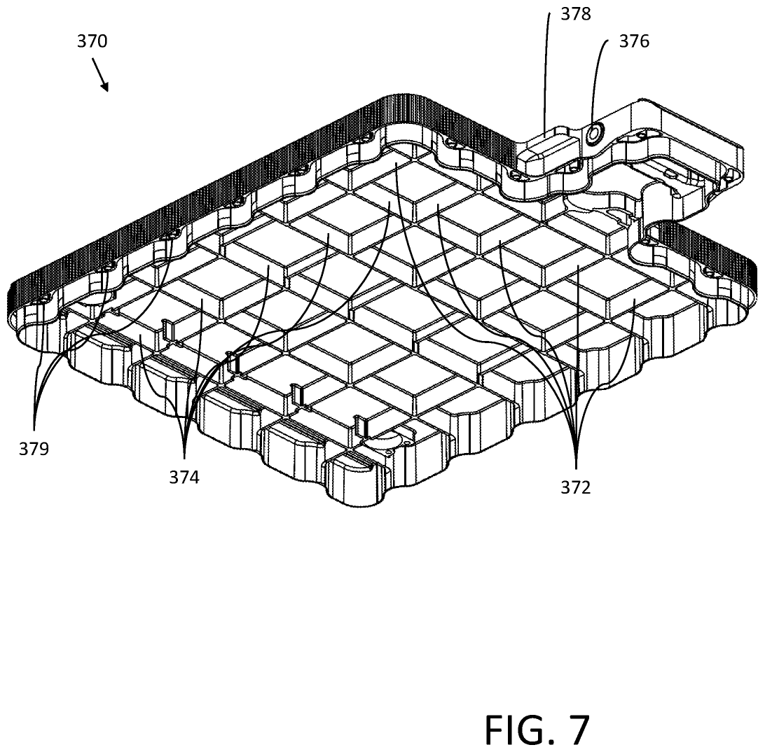

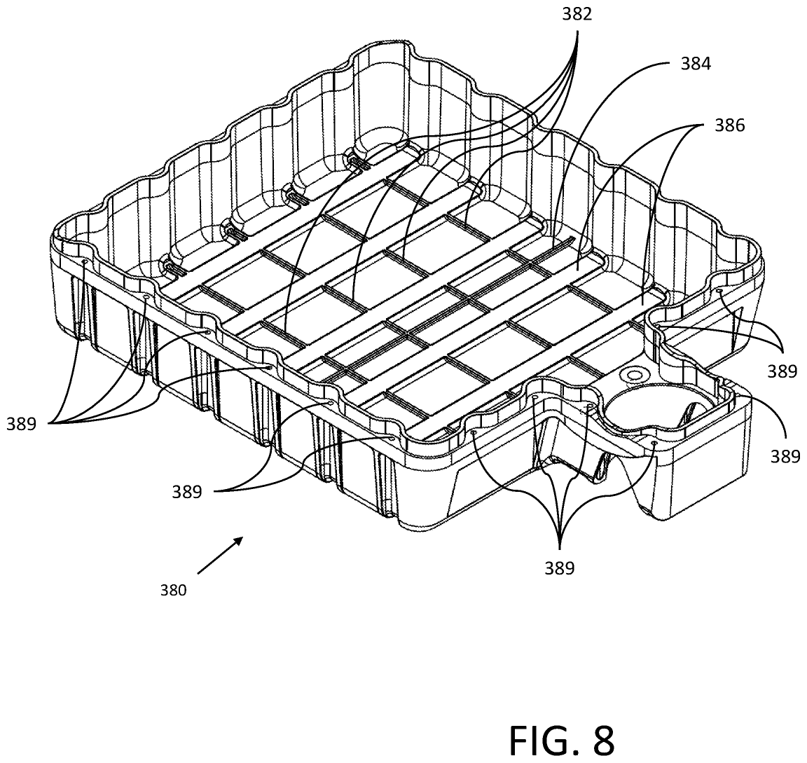

The top housing portion 370 is preferably a thin-walled structure having a substantially uniform wall thickness suitable for injection molding from plastic or composite materials, as illustrated in FIG. 7. A pair of wings 378 extends outward from the top surface 314 on either side of the pivot hole 376. The wings 378 reduce the chance an operator of the watercraft 300 could step on or otherwise accidently push down on the sides 334 to open the handle 330. A series of holes (e.g., 379) are placed around the perimeter on the underside of the top housing portion 370. Fasteners 388 (shown in FIG. 9) extend through complementary holes (e.g., 389 shown in FIG. 8) in the bottom housing portion 380 and are threaded into the holes 379 to fasten the top housing portion 370 to the bottom housing portion 380 and form a continuous watertight seal around the perimeter of the housing.

The bottom housing portion 370 is preferably a thin-walled structure having a substantially uniform wall thickness suitable for injection molding from plastic or composite materials, as illustrated in FIG. 8. The bottom housing portion 380 includes a shallow transverse ridge 384 and longitudinal ridges 382. As discussed above, channels 381 are disposed on the bottom housing portion. The broad ridges 386 are the projection of the channels 381 into the interior space of the bottom housing portion 380. The transverse ridge 384, longitudinal ridges 382, and broad ridges 386 provide structural rigidity and are a surface for the battery cassette 500 (shown in FIG. 9) to rest upon.

FIGS. 9A and 9B illustrate the components of the container 302. The deck pad 307 is affixed to the top housing portion 370. A resilient seal 371 is disposed between the top housing portion 370 and the bottom housing portion 380. A battery cassette 500 is sandwiched between the top housing portion 370 and the bottom housing portion 380, and fully enclosed within the container 302. While one cassette 500 is shown, in other embodiments, several battery cassettes 500 may be disposed within the container 302 and electrically connected to one another. The container is preferably fully sealed, with a positive pressure (relative to atmosphere) to reduce the likelihood of water ingress. In alternate embodiments, Gore vents in the container 302 may allow internal the container pressure to be equalized to external pressure without allowing water ingress.

The battery cassette 500 includes top insulator 504 and bottom insulator 502, both of which are constructed from a sheet of fiber reinforced fire resistant sheet. The top insulator 504 and bottom insulator 502 protect the battery cassette 500 from electrical shorts and provide thermal protection between the cells 550 (shown in FIG. 12, for example) and the outer housing portions 370 and 380.

A top battery management system 525 mounts to the top surface of the battery cassette 500. The top battery management system 525 includes sensing inputs for each parallel bank of battery cells 550, and includes bank-level fusing to protect the battery cells from shorts or other cell malfunctions at the module level.

The top housing portion 370 is fastened to the bottom housing portion 380 using screws 388, which pass through holes 389 in the bottom housing portion 380 and thread into threaded inserts 381 disposed in the holes 379 in the top housing portion 370. The threaded inserts 381 can either be molded into the top housing portion 370 or installed after molding.

Isolation strips 387 are disposed in channels provided in the lower housing portion 380, as discussed above. The socket 100 receives pins 116 (labeled in FIG. 5) and mounts to the connector board 150 as discussed above. Handle 330 pivots within the hole 376 (labeled in FIG. 5), within the top housing portion 370 as discussed above.

FIG. 10 illustrates how the components of the container 302 fit together when assembled. The resilient seal 371 is illustrated in cross-section between the top housing portion 370 and the bottom housing portion 380. One of the fasteners 389 is also illustrated, passing through a boss located at the perimeter of the bottom housing portion 380, and threaded into the top housing portion 370.

The battery cells 550 are substantially cylindrical. The anode end 551 and the cathode end 552 of each battery cell 550 are received in a top or bottom tray 520/560. Top cell connection boards 510 are stacked on top of the top tray 520, and bottom cell connection boards 570 are beneath the bottom tray 560. In the preferred embodiment, the top cell connection boards 510 are printed circuit boards (PCBs) that include a nickel tab 512 and a fuse 513 for each battery cell 550, and the bottom cell connection boards 570 are printed circuit boards (PCBs) that include a nickel tab 572 and a fuse (not shown) for each battery cell 550. In the preferred embodiment, a separate fuse is provided for each battery cell 550, for example fuses 513 and corresponding fuses (not shown) mounted on a bottom cell connection boards 570. In alternative embodiments, the nickel tabs 512 and 572 may have a shape such that the tabs 512 and 572 function as a fuse.

The connector pins 116 are illustrated in cross-section, attached to the connector board 150. Within the socket 100, a first end of the external connectors 142 receive the connector pins 116. A second end of the external connectors 142 are configured to receive pins from a plug mounted on the top of the strut 308.

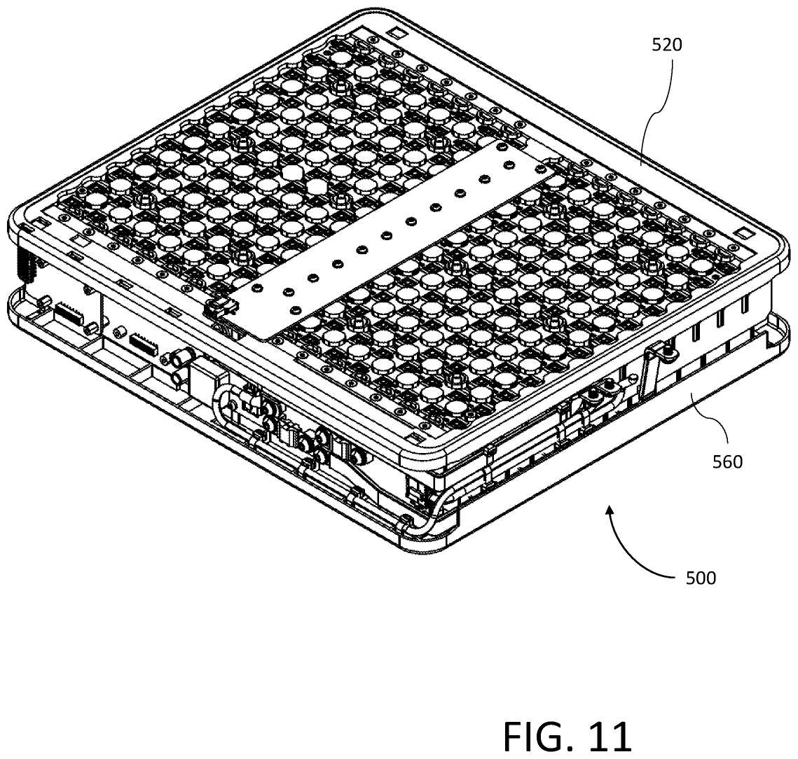

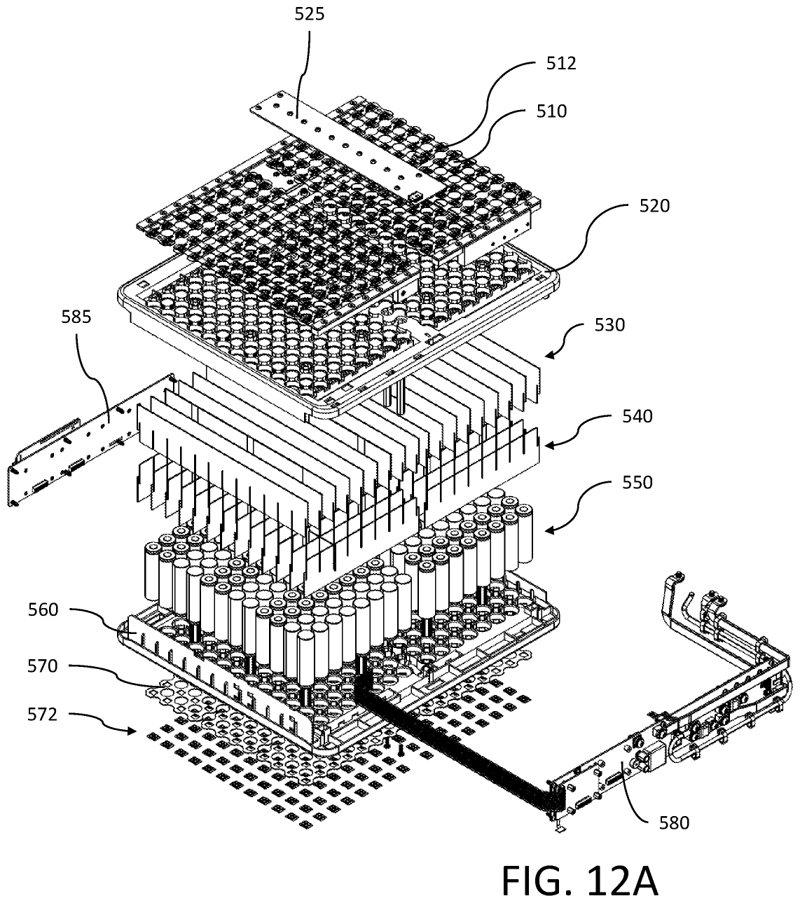

FIG. 11 illustrates the cassette 500, with top insulator 504 removed. The top tray 520 and the bottom tray 560 provide a rigid structure that contains the battery cells 550, as discussed further below.

FIGS. 12A and 12B illustrate the components of the battery cassette 500 in greater detail. The top cell connection boards 510 are designed to nest within the top battery tray 520. The battery cells 550 are square packed, leaving space for transverse fire barriers 530 and longitudinal fire barriers 540. Cell spacing and FR4 fire isolators preferably isolate each battery cell 550 from its neighbors to prevent thermal propagation. The fire barriers 530 and 540 are cut from rigid fiber reinforced, fire resistant sheet preferably a fire retardant fiberglass board, for example 3M™ TuFR Hybrid Organic/Inorganic Paper board. The fire barriers 530 and 540 are preferably constructed from phase changing composite (PCC) materials to protect against thermal runaway. For example, a resin in the PCC sheeting comprising the fire barriers 530 and 540 may be selected to melt at temperatures present during a thermal runaway, causing fibers in the fire barriers 530 and 540 to expand and thermally insulate the malfunctioning battery cell from neighboring cells. Similarly, in preferred embodiments, phase changing materials (e.g., wax) are disposed in the container and used to absorb energy (e.g., heat from battery) via material phase change (e.g., solid to liquid). Alternative materials are also available for the fire barriers 530 and 540 and may provide a lighter weight structure. Alternative arrangements of the battery cells 550 and fire barriers 530 and 540 could also be employed, including triangular or hexagonal packing. In preferred embodiments, each battery cell 550 is wholly isolated from its neighboring cells. This reduces the chance that thermal runaway in a given battery cell 550 can propagate to neighboring cells. A preferred embodiment of the container was burn tested 3000° C. for 5 seconds, has been UL4 V0 rated, and has a maximum continuous service temperature of 140° C.

In addition to reducing the chance of thermal runaway, the fire barriers 530 and 540 provide a rigid structure that supports at least part of any load placed on a top surface 314 of the container 302. The height of the fire barriers 530 and 540 fills the distance between the top tray 520 and bottom tray 560 The fire barriers 530 and 540 provide a stiff structure, and reduce the load placed on the battery cells 550. Reducing the load on placed on the battery cells 550 aids to mitigate the degree of flexing between the battery cells 550 and printed circuit boards 580 and 585 to which the battery cells 550 are mounted. This reduces the stress experienced by a connection point (e.g., soldering) of the battery cells 550 to the printed circuit boards 580 and 585, which could otherwise result in the battery cell 550 becoming disconnected from the circuit boards 580 or 585.

Printed circuit boards 580 and 585 are located peripheral to the battery cells. The printed circuit boards 580 and 585 include battery management system circuitry, circuitry that provides active safety features, GPS, IMU, storage memory, and communication circuitry, as discussed above with respect to FIG. 16. Sensors for temperature, pressure, smoke, water, humidity, and inertial measurement may be provided on printed circuit boards 580 and 585. In a preferred embodiment, high temperature sensing is used to disable the battery unit 302. High temperature can indicate improper operating environment and/or malfunction of battery cells 550. As discussed above, in preferred embodiments the container 302 is pressurized above atmospheric pressure. Pressure sensors in the container 302 are configured to detect a drop in pressure that might indicate a breach of the watertight container 302. The battery unit 302 can be disabled until a trained technician inspects it. In some embodiments, a smoke sensor disposed within the container 302 can detect fire caused by thermal runaway, allowing the battery management system to disable the battery unit 302. In a preferred embodiment, water and humidity detection are performed by using two wire leads and monitoring the resistance between the two wires. When the resistance drops due to humidity or water fouling, the system is designed to disable the battery.

GNSS and communication circuitry may also be provided on printed circuit boards 580 and 585. Communication circuitry preferably includes a CAN-bus controller or transceiver for communicating with an electronic speed controller mounted in close proximity to the motor 310 of the watercraft 300. Communication circuitry preferably also includes a transceiver for external communications, for transmitting data to a remote server via Wi-Fi, Bluetooth, or cellular data as would be known to an ordinarily skilled circuit designer. GNSS circuitry may also be provided on printed circuit boards 580 and 585, for capturing the location of the container 302. The GNSS circuitry may also be used to capture telemetry data of the watercraft, including location, speed, and heading.

Printed circuit boards 580 and 585 may also include safety features designed to protect the battery cells 550 from the harsh shorebreak environment. In preferred embodiments, all safety systems for the battery cells 550 are included in the container 302, making it a modular device. A preferred embodiment includes a three-tiered fusing structure. Three types of fuses are provided, designed to provide synchronized action across three levels: individual cell-level (25 A), bank level (implemented as a 0 Ohm resistor), pack level (150 A). At the pack level, an analog short circuit detection device (not shown) is provided, having a 10 μs response time. The short circuit detection device is resettable and prevents permanent system-level damage. Individual cell-level fuses are capable of isolating a malfunctioning cell and enable use of the battery even if some cells fail. The printed circuit boards 580 and 585 include circuits for monitoring the status of each individual fuse and identifying fuses that have blown. Fuse blow timing characteristics across the fuse tiers are matched to the profile of failure to avoid premature triggering.

A solid-state switch, fuse or contactor (not shown) is preferably used to disconnect the main power pins of the connector when it is disconnected from the watercraft 300. The solid-state switch may comprise high power MOSFETs for switching the power to the pins of the connector on and off. The battery management system may use one of several mechanisms for detecting that it is disconnected from the watercraft 300. In one example, the fuse disconnects when communication signals are not present. Electrical characteristics, including inductance, resistance, or capacitance can be measured and used to detect disconnection. In a preferred embodiment, a capacitance associated with bulk capacitors located in the electronic speed controller is used to detect when the container 302 is either connected or disconnected from the watercraft 300. Other mechanisms may also be used, including a pin interlock or proximity sensor relying upon a magnet or other means as would be known to a person having ordinary skill in the art. The power may also be disconnected from the power pins of the connector in response to detecting a short within the battery. In one example, the battery management system includes an analog short circuit detection circuitry that is configured to detect a short within the battery. Upon detecting a short, the battery management system, or the analog short circuit detection circuitry, may be configured to quickly switch the solid-state switch to disconnect the power to the power pins before the high current does damage to any electronics.

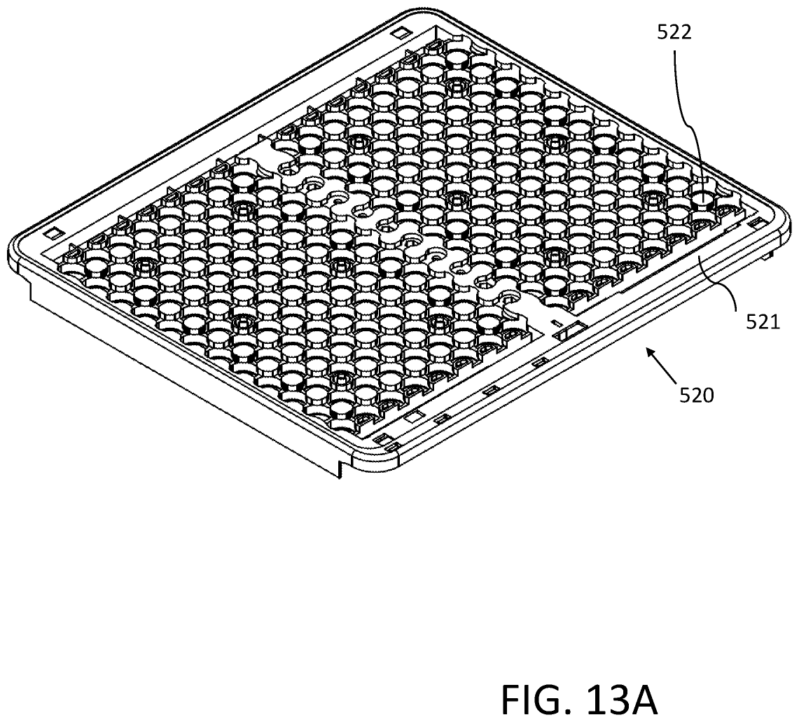

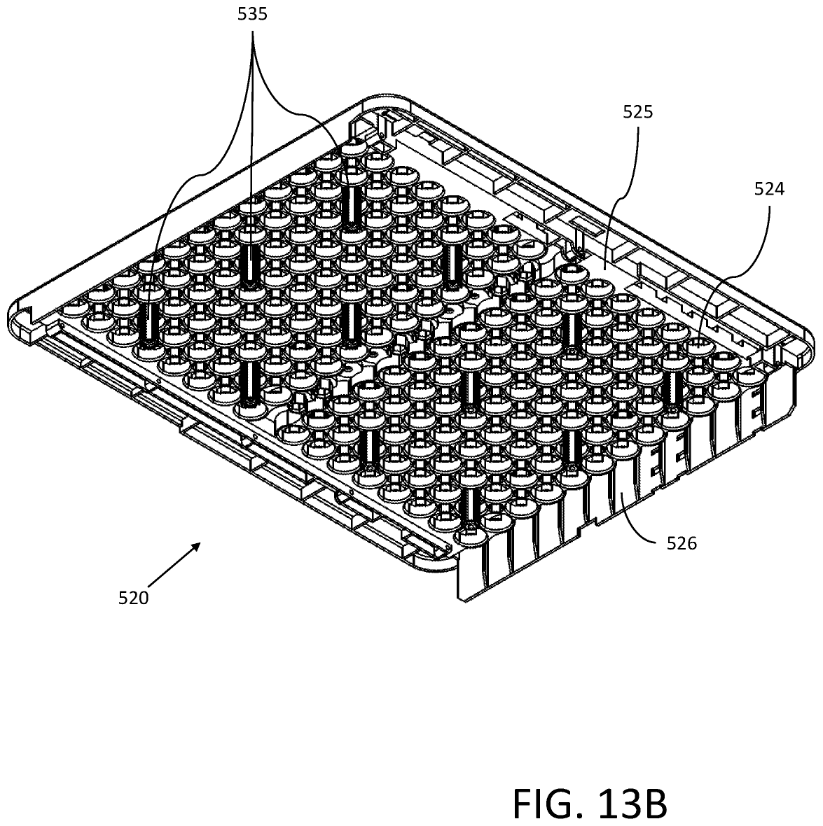

FIGS. 13A and 13B illustrate a top tray 520. In preferred embodiments, the top tray 520 and bottom tray 560 are identical, designed symmetrically to fit together and sandwich the battery cells 550 and fire barriers 530 and 540. In alternative embodiments, the top tray 520 and bottom tray 560 differ slightly, but both the top tray 520 and the bottom tray 560 will include the features discussed below. Accordingly, the illustrations in FIGS. 13A and 13B apply to both the top tray 520 and bottom tray 560 even though only the top tray 520 is discussed. FIG. 13A shows an outside surface of the tray 520. Raised cylindrical projections 522 are placed between the battery cells 550. The cylindrical projections are weight-bearing surfaces, designed to support, for example, the top housing portion 370 of the container 302. In preferred embodiments, an insulator 504 is placed between the tray 520 and the top housing portion 370. Weight applied to the top surface 314 of the container 302 is transmitted through the top housing portion 370 to the insulator 504, and then through the raised cylindrical projections 522 and the perimeter top surface 521. Top cell connection boards 510 are nested between the cylindrical projections 522, such that the boards 510 and components mounted thereon are not subject to the weight applied to the container 302.

FIG. 13B shows an inside surface of the tray 520. Cylindrical pockets 524 are provided that are designed to receive a top or bottom end of each battery cell 550. In a preferred embodiment, the battery cells 550 are standard 18650 lithium ion cells. Other similar cells may be used, or the container may be designed for non-standard cells. The tray 520 includes a substantially flat surface 525 designed to interface with the fire barriers 530 and 540 located between each battery cell. When assembled as part of battery cassette 500, the substantially flat surface 525 transmits weight from the tray 520 to the fire barriers 530 and 540, such that the fire barriers support weight placed on the top surface 314 of the container 302. Posts 535 are received within the tray 520 and serve to align the top tray 520 and bottom tray 560 when joined together. The posts 535 also include slots to align and hold the fire barriers 530 and 540 together. Each post 535 includes a hole on the top end into which a fastener (e.g., a screw) may be inserted to join the top tray 520 to the post 535 and a hole on the bottom end into which a fastener (e.g., a screw) may be inserted to join the bottom tray 560 to the post 535. The posts 535 thus attach the top tray 520 to the bottom tray 560.

FIG. 14 shows the internal components of the battery cassette 500, without the top insulator 504, top cell connection boards 510, and top tray 520. The transverse fire barriers 530 each have series of slots 532. Each slot 532 corresponds and mates with one of the longitudinal fire barriers 540. The longitudinal fire barriers 540 each have a series of slots 542. Each slot 542 corresponds and mates with one of the transverse fire barriers 530. When assembled, the fire barriers 530 and 540 form a lattice with a pocket for each battery cell 550. When assembled within the battery cassette 500, the top edge of each fire barrier 530 and 540 is in close contact with an inside surface 525 of the top tray 520. Likewise, the bottom edge of each fire barrier 530 and 540 is in close contact with an inside surface of the bottom tray 560. Each battery cell 550 has an anode (positively charged) end 551 and a cathode (negatively charged) end 552. Pockets 564 in the bottom tray 560 are designed to receive the respective anode end 551 and cathode end 552 of the battery cells 550. A fuse 572 is provided for each battery cell 550 to individually protect each battery cell 550.

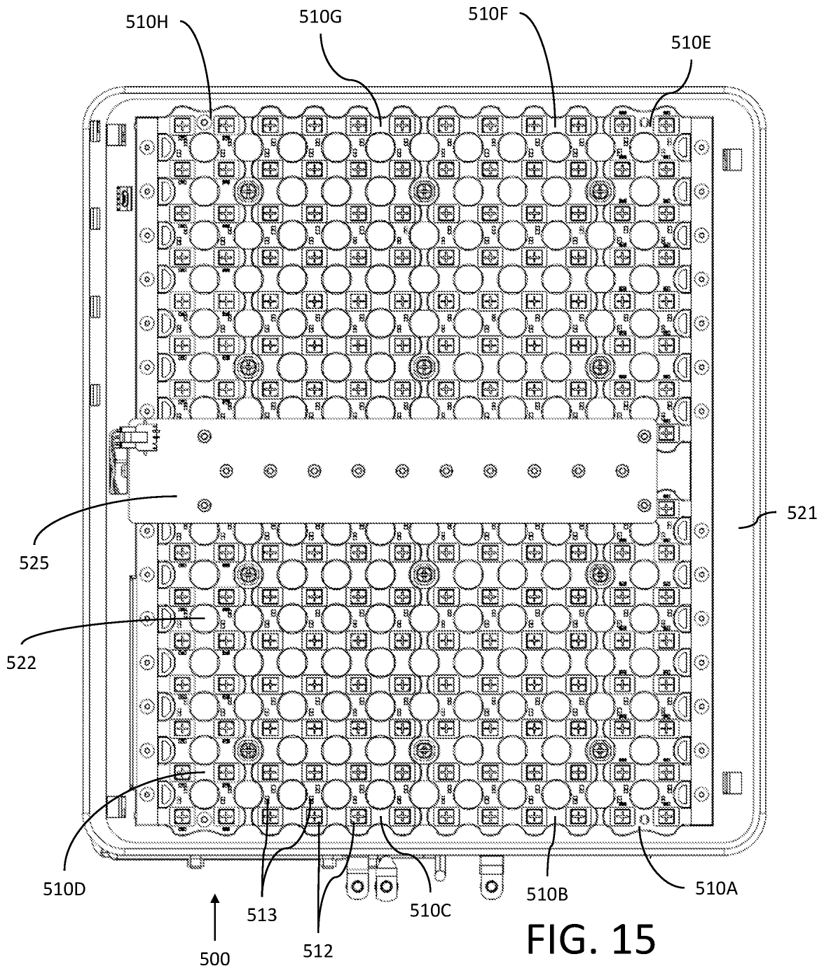

FIG. 15 illustrates the top battery tray, showing the top cell connection boards 510 nested among the circular projections 522. A nickel tab 512 is mounted on each of the top cell connection boards 510, at the interface between each battery cell 550 and its respective top cell connection board 510. A fuse 513 is mounted on the top connection boards 510 adjacent to and corresponding to each of the nickel tab 512 for each cell 550. The fuse configuration illustrated in FIG. 15 for top cell connection boards 510 is duplicated for the bottom cell connection boards 570. As illustrated, the preferred embodiment includes eight separate top cell connection boards 510A-510H. Boards 510A, 510D, 510E, and 510H each support 16 battery cells 550. Boards 510B, 510C, 510F, and 510G each support 32 battery cells 550. The cells are organized into modules of battery cells 550 for management and higher-level fuse protection.

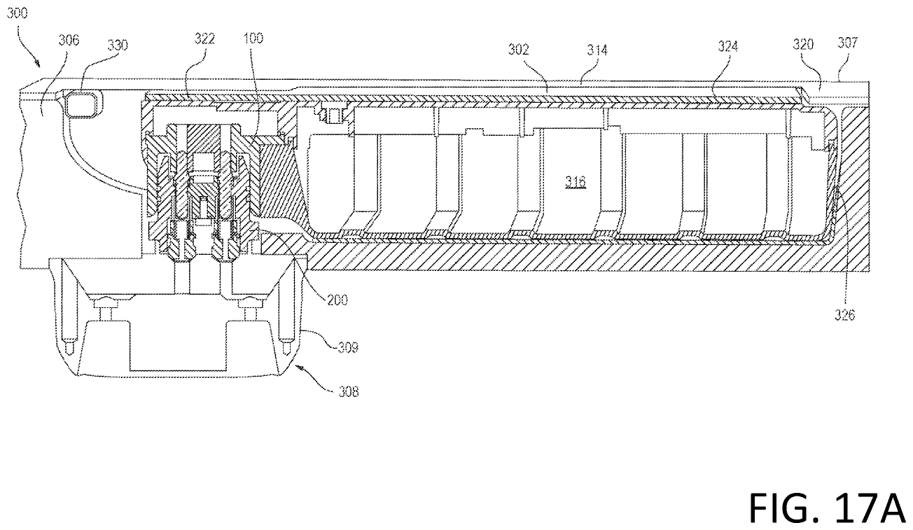

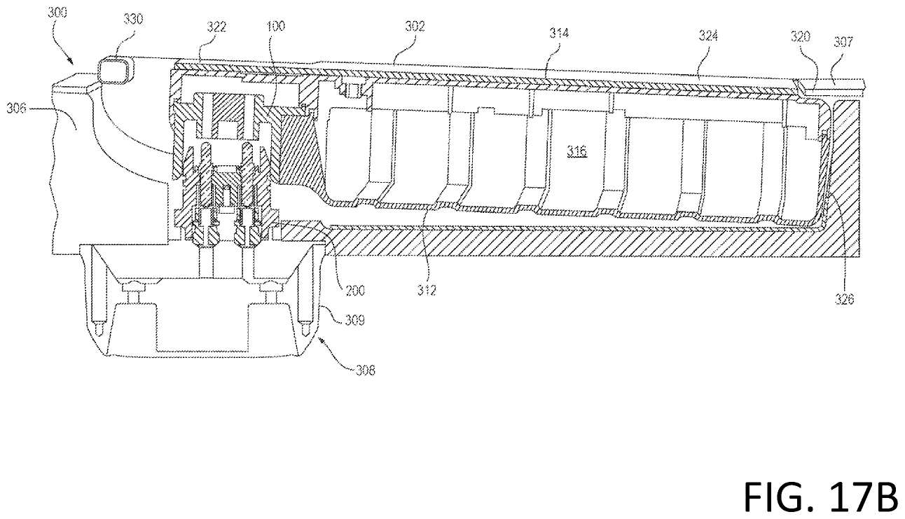

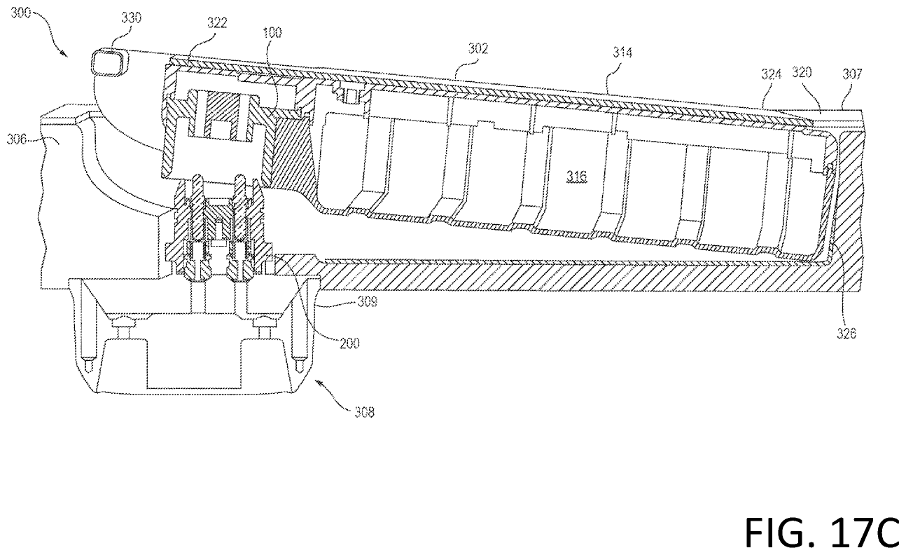

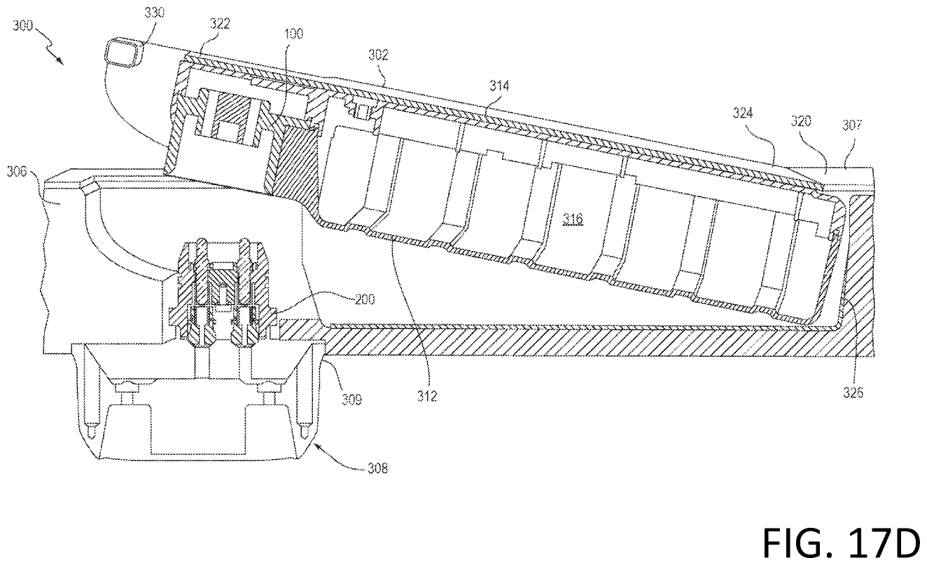

With reference now to FIGS. 17A-D, the images show container 302 being removed according to an embodiment. As shown, the container 302 includes a cavity 316 for housing the battery cassette 550 as described above. The socket 100 is attached at an end 322 of the container 302, with the socket 100 facing downward or away from the upper surface 314 of the container 302. In FIG. 17A, the plug 200 of the watercraft 300 is shown fully inserted into the socket 100. To remove the socket 100 from the plug 200, the end 322 of the container 302 may be moved in the upward direction, away from the plug 200 and out of the cavity 312 of the watercraft 300. With reference to FIGS. 17B-D the end 322 of the container 302 having the socket 100 is shown progressively moving away from the plug 200. The container 302 is shown pivoting about an end 324 of the container opposite the socket 100, until the socket 100 is no longer in contact with the plug 200 as shown in FIG. 17D. The container 302 may then be removed from the cavity 312 of the watercraft 300.

To insert the container 302 into the cavity 312 of the watercraft 300 and connect the plug 200 of the watercraft 300 to the socket 100 of the container 302, the steps for removing the container 302 may be reversed. With reference to FIG. 17D, the end 324 of the container 302 opposite the socket 100 may be positioned within the cavity 312. The end 324 may be brought near or into contact with the end 326 of the cavity 312 opposite the plug 200. Then, as shown progressively from FIG. 17C to FIG. 17A, the socket end 322 of the container is pivoted about the end 324 opposite the socket 100 to bring the socket 100 into contact with the plug 200 of the watercraft 300. As the socket 100 contacts the plug 200, the plug 200 may pivot slightly to align with the socket 100. The pins of the plug 200 may also pivot or move slightly to align with the pin connectors 142 of the socket 100. The end 322 of the container 302 may be forced downward and into the cavity 312 until the plug 200 is fully received within the socket 100. This may occur when the upper surface 314 of the container 302 is horizontal and/or substantially coplanar with the deck 306 of the watercraft 300.

As shown in FIGS. 17A-D, the container 302 includes a handle 330 attached to the end 322 of the container 302 including the socket 100. The handle 330 may be used to pivot the container 302 about the end 324 opposite the socket 100 to connect and disconnect the socket 100 from the plug 200. The handle 330 may provide additional leverage to the user in inserting or extracting the container 302 from the cavity 312 of the watercraft 300.

In some embodiments, the deck 306 of the watercraft 300 may include a tongue 320 that extends over the upper surface of the cavity 312. The end 324 of the container opposite the socket 100 may extend underneath the tongue 320 when fully inserted into the cavity 312. During insertion, when the end 324 of the container is positioned within the cavity, a portion of the upper surface 314 at end 324 of the container 302 may be brought into contact with the tongue 320. For example, an installer may slide the container 302 along the cavity 312 until the upper surface 314 contacts the tongue 320. As the end 322 of the container 302 including the socket 100 is pivoted toward the plug 200 and into the cavity 312, the container 302 may pivot about the point of contact between the container 302 and the tongue 320. As the end 322 of the container 302 nears the plug 200, the bottom surface of the container 302 may slide or translate along the bottom of the cavity 312 in the direction opposite the plug 200. Once the socket 100 contacts or engages the plug 200, the container 302 no longer slides or translates, but rotates about the point of contact between the container 302 and the bottom surface of the cavity 312 until the plug 200 is fully inserted into the socket 100. This design, where the translation of the container 302 occurs before the socket 100 engages the plug 200, reduces the amount of stress and strain applied to the plug 200 in connecting the socket 100 to the plug 200. Since the container 302 is substantially only rotating about the point of contact of the container 302 and the bottom surface when the plug 200 and the socket 100 interconnect, the plug 200 only needs to pivot slightly to align with the socket 100. Further, the lateral forces on the plug 200 are minimized because, at the point where the plug 200 contacts the socket 100, the container 302 lacks freedom to translate within the cavity 312. This may reduce the risk of damage to the plug 200 during insertion and removal of the container 302.

The distance between the tongue 320 and the bottom of the cavity 312 may be the same or slightly smaller than the height of the container 302. Thus, when the container 302 is positioned within the cavity 312 with a portion of the container 302 between the tongue 320 and the bottom surface of the cavity 312, the end 324 of the container 302 is held firmly in place by watercraft 300, being slightly compressed by the tongue 320 and the bottom of the cavity 312. The resilient isolation strips 387 described above may compress as the container 302 locks into place within the cavity. The isolation strips 387 advantageously reduce the need for tight tolerances when forming the cavity 312 within the board 305.

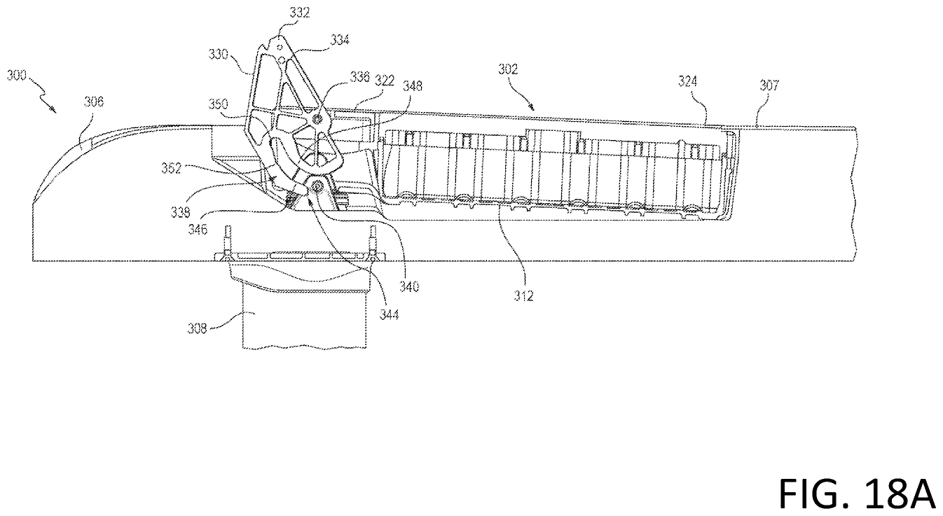

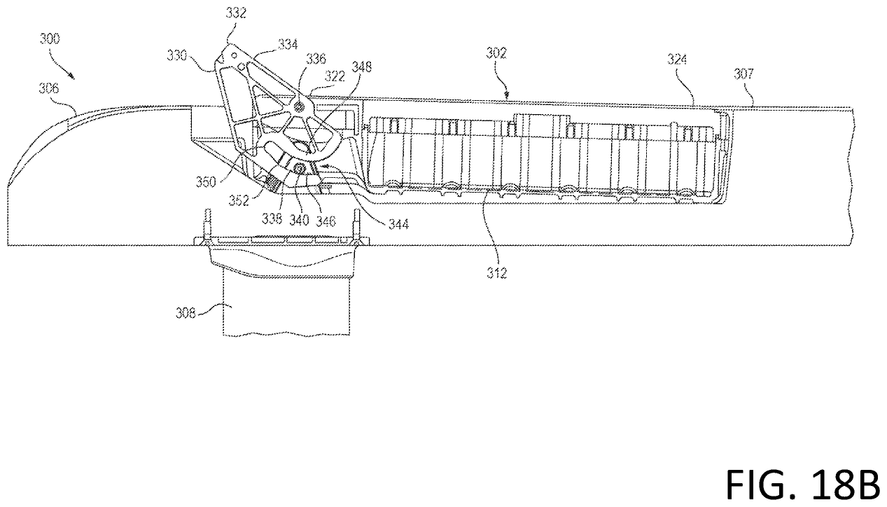

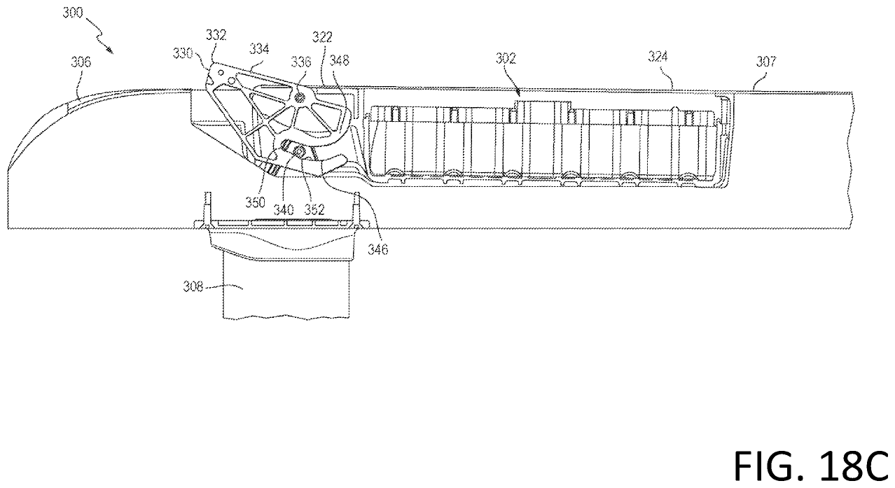

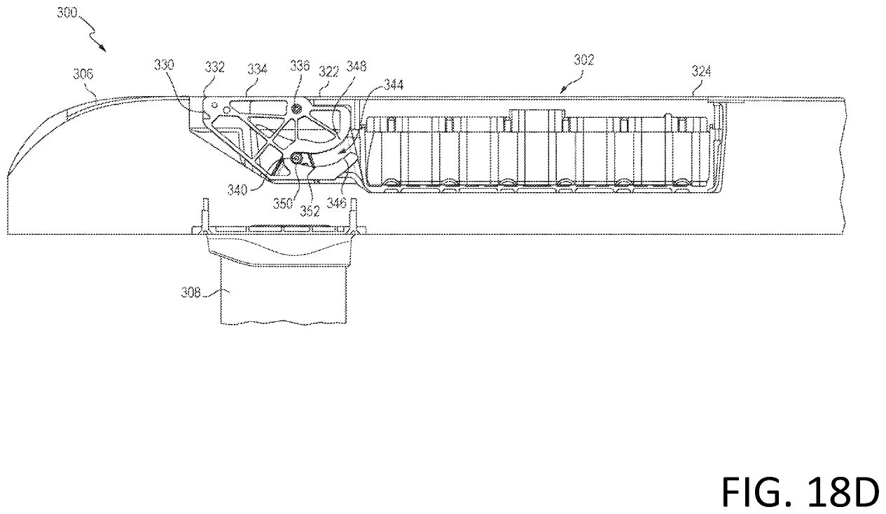

In yet another embodiment, shown in FIGS. 18A-D and 119A-D, the handle 330 is rotatably attached to the container 302. The handle 330 includes a gripping portion 332 having two ends, each end attached to an arm 334. The arm 334 extends from the gripping portion 332 to the attachment point 336 at the end of the arm 334 opposite the gripping portion 332. The arm 334 is rotatably attached to the container 302 by the bar 337 (illustrated in FIGS. 5 and 6), allowing the gripping portion 332 of the handle 330 to rotate about the attachment point 336. Each arm 334 further includes a slot 338 for receiving pins 340 affixed to the upper end 309 of the strut 308 of the watercraft 300. As shown the pins 340 extend from the attachment structure 342 at the upper end 309 of the strut 308 to which the plug 200 is attached. In other embodiments, the pins 340 may protrude from a surface of the cavity 312 or the plug 200. Each slot 338 includes a mouth 344 for receiving the pin 340. The slots 338 include a lower cam surface 346 and an upper cam surface 348 that the pins 340 engage as the pins 340 move along the slot 338. The lower cam surface 346 includes an inner detent 350 and an outer detent 352 for receiving the pin 340. When the pin 340 is within a detent 350, 352 the pin 340, the handle 330 does not move substantially relative to the pin 340 without the application of force on the handle 330.

In operation, when inserting the container 302, the end 324 of the container 302 opposite the socket 100 is positioned within the cavity 312 of the watercraft 300, for example as described above in regard to FIGS. 17A-D. As the socket 100 of the container 302 is pivoted towards the plug 200, the handle 330 is in an upward position, causing the mouths 344 of the slots 338 to be near pins 340. The handle 330 may be rotated downward, causing the pins 340 to enter the slots 338 via the mouths 344, for example, as shown in FIG. 18B. An installer may rotate the handle 330 by moving the gripping portion 332 about the attachment point 336. The pins 340 may slide along the lower cam surface 346 of the slot 338 during insertion. The handle 330 is further rotated about the attachment point 336, causing the lower cam surface 346 of the handle 332 to apply a force to the pin 340 and move the plug 200 further into the slot 100. As the pin 340 is moved along the lower cam surface 346 by rotation of the handle 330, the pin 340 enters the outer detent 352, as shown in FIG. 18C. To move the pin 340 beyond the outer detent 350 may require increased force to cause the plug 200 to be fully inserted into the socket 100 of the container 302. Providing the outer detent 352 along the slot 338 provides tactile feedback to the installer, providing the opportunity to ensure that the plug 200 is properly aligned with the socket 100 before fully inserting the plug 200 into the socket 100. With this tactile feedback, the installer may be able to determine whether the plug 200 is properly entering the socket 100 or whether debris is interfering or whether the connectors are misaligned. To fully insert the plug 200 into the socket 100, an additional downward force must be applied to the gripping portion 332 of the handle 330 to cause the pin 340 to move from the outer detent 352 to the inner detent 350 of the slot 338 as shown in FIG. 18D. Once the pin 340 is resting in the inner detent 350 of the slot 338, the plug 200 is fully inserted within the socket 100. The gripping portion 332 and a top surface of the arms 334 may be substantially horizontal and even co-planar with the deck 306 of the watercraft 300. Resilient components within the connector (e.g., socket boots and plug boots and the air compressed within the sealed space) provide a force that would drive the plug 200 apart from the connector 100, but for the pin 340 engaged in the slots 338. This upward force tends to keep the pin 340 within the detent 350 and prevents the handle 330 from rotating upward. Thus, providing an inner detent 350 at the point of where the plug 200 is fully inserted into the socket 100 requires additional force to be applied to the handle to remove the socket 100 from the plug 200, and otherwise retains the handle 330 at the fully inserted position.

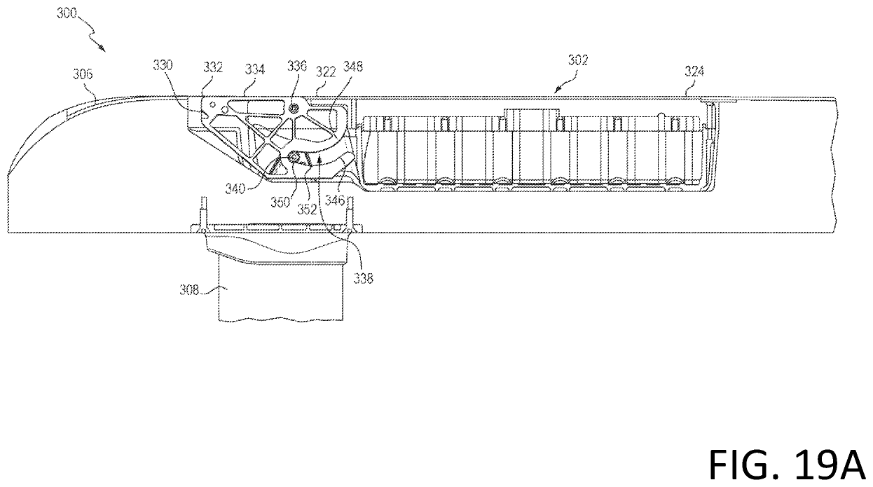

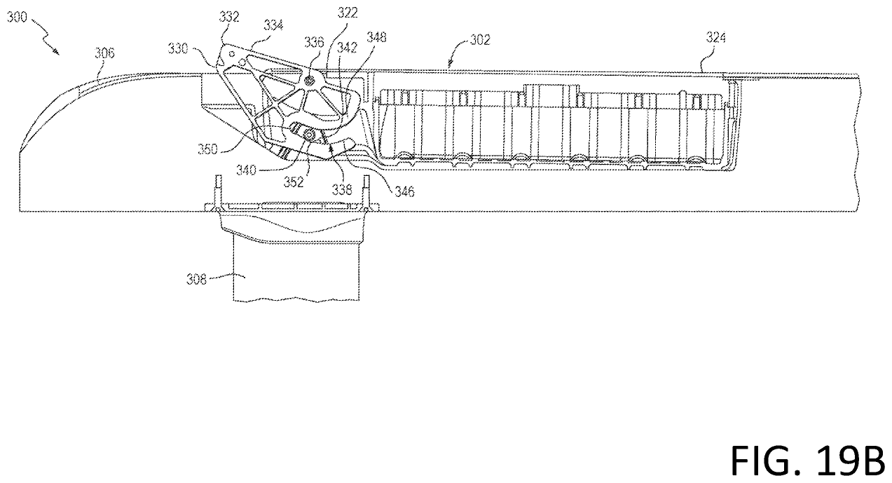

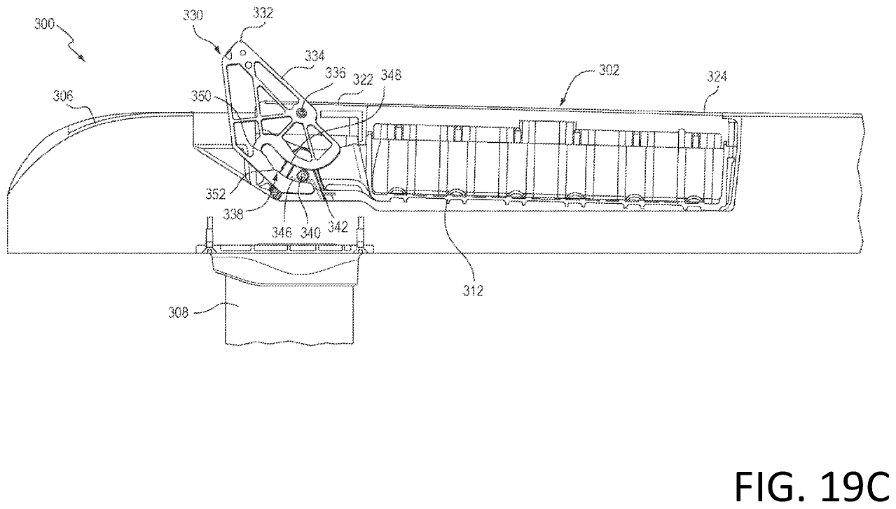

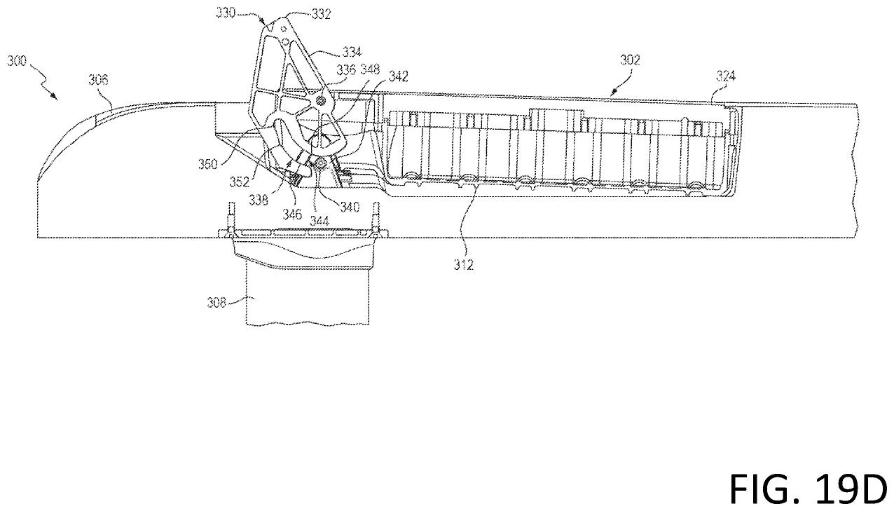

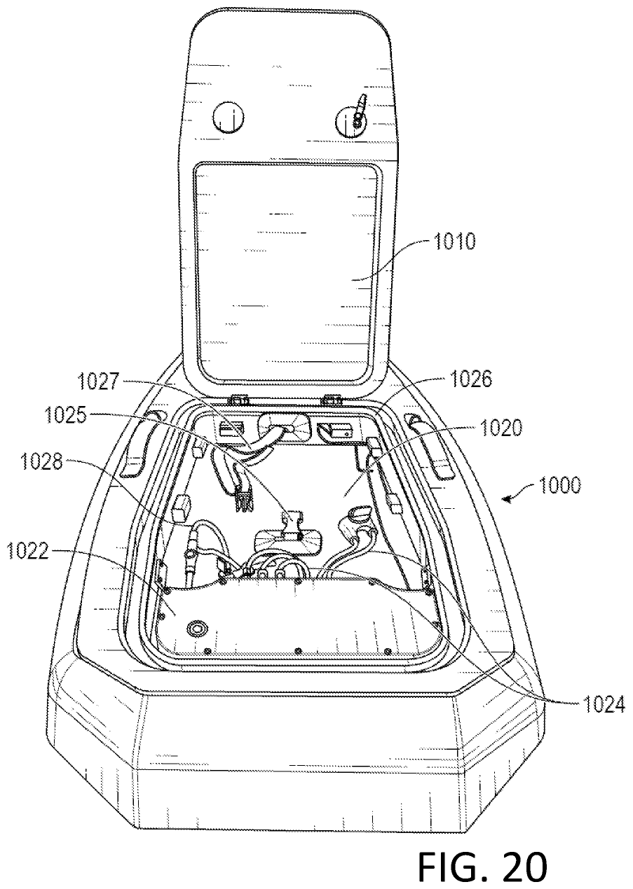

With reference to FIGS. 19A-D, when removing the container 302 from the watercraft 300, the gripping portion 332 of the handle 330 is rotated upward. This causes the upper cam surface 348 of the slot 338 to engage the pin 340. The upper cam surface 348 applies a force to the pin 340 to force the socket 100 upward and away from the plug 200. The upper cam surface 348 of the slot 338 may be a smooth curved surface with no detents. This allows the handle 332 to be smoothly moved from the position where the plug 200 is fully inserted into the socket 100 to the position where the plug 200 is removed from the socket 100 with an approximately constant force. Once the pin 340 is no longer within the slot 338 of the handle 330, the handle 330 may be used to pull the end 322 of the container 302 upward and away from the plug 200. Once the plug 200 is fully removed from the socket 100, the container 302 may be pivoted, slid, and removed from the container, for example, as described in regard to the embodiment of FIG. 17A-D.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

1. A passively cooled waterproof propulsion unit for a watercraft, the propulsion unit comprising:
a substantially cylindrical housing including an outer wall having an external surface and an internal surface, the cylindrical housing including a first end cap attached at a first end of the housing, the first end cap including an attachment interface configured to be mounted to a strut of a watercraft such that at least a portion of the external surface of the outer wall of the housing is configured to contact a fluid surrounding the housing when the watercraft operates within the fluid;
an electric motor disposed within the housing; and
an electronic speed controller electrically coupled to the electric motor and configured to provide electrical power to the electric motor to operate the electric motor, the electronic speed controller including a plurality of transistors and positioned within the housing such that the plurality of transistors are proximate the internal surface of the outer wall of the housing.

2. The propulsion unit of claim 1 wherein the housing includes an internal wall that defines a first compartment and a second compartment within the housing, the first compartment containing the electronic speed controller and the second compartment containing the motor, wherein a portion of a shaft of the motor extends through the internal wall into the first compartment.

3. The propulsion unit of claim 2 further comprising a seal disposed between the shaft of the motor and the internal wall to form a fluid tight seal between the first compartment and the second compartment.

4. The propulsion unit of claim 2 wherein the electronic speed controller includes a circuit board to which the plurality of transistors are mounted and a thermally conductive layer affixed to a side of the circuit board and in thermal contact with the internal surface of the outer wall of the housing.

5. The propulsion unit of claim 1 wherein the electric motor further comprises:
a rotor and
a stator with an outer portion in thermal contact with the internal surface of the outer wall of the housing.

6. The propulsion unit of claim 1 further comprising:
an end-cap seal disposed between the housing and the first end cap configured to prevent fluid from entering the housing
at least one hole disposed within the first end cap;
a conductor disposed within the at least one hole within the first end cap; and
a conductor seal disposed within the at least one hole of the first end cap, the conductor seal configured to form a fluid tight seal between the conductor and the first end cap.

7. The propulsion unit of claim 6 further comprising:
a conductor cable having a threaded attachment end with a seal;
threads formed within the at least one hole of the first end cap for attachment to the conductor cable attachment end;
wherein the seal of the conductor cable forms a fluid tight barrier between the first end cap and the conductor cable upon attachment of the attachment end to the first end cap.

8. The propulsion unit of claim 1 further comprising a sensor mounted to the housing for detecting a distance between the propulsion unit and a surface of the fluid in which the watercraft is operating.

9. The propulsion unit of claim 8 wherein the sensor is at least one of an ultrasonic sensor and a radar sensor.

10. The propulsion unit of claim 1 further comprising one or more hydrofoil wing mounted to the housing.

11. The propulsion unit of claim 1 further comprising:
a movable control surface disposed on the external surface of the outer wall; and
an actuator disposed within the housing and operably coupled to the movable control surface to adjust a position of the movable control surface.

12. The propulsion unit of claim 1 further comprising a battery disposed within the housing.

13. The propulsion unit of claim 1 wherein the plurality of transistors are mounted at an outer edge of a substantially circular circuit board of the electronic speed controller.

14. The propulsion unit of claim 1 wherein the electric motor includes a shaft extending through a second end cap attached at a second end of the housing and further comprising a seal disposed between the shaft and the second end cap of the housing configured to inhibit fluid from entering the housing.

15. The propulsion unit of claim 1 wherein the electronic speed controller includes a first substantially circular circuit board having the plurality of transistors and a second substantially circular circuit board having a plurality of bulk motor capacitors, the first circuit board concentric with the second circuit board.

16. The propulsion unit of claim 1 wherein the housing includes a first cylindrical portion and second cylindrical portion, the first cylindrical portion configured to be attached the second cylindrical portion, wherein the first cylindrical portion contains the electronic speed controller and the second cylindrical portion houses the electric motor.

17. An electric watercraft comprising:
a flotation portion;
a strut having an upper end coupled to the flotation portion;
a waterproof propulsion system mounted to the strut and including a housing containing an electric motor and an electronic speed controller;
the electric motor having a shaft, the shaft including a magnet coupled thereto;
the electronic speed controller positioned adjacent an end of the electric motor and electrically coupled to the electric motor and configured to provide electrical power to the electric motor to operate the electric motor; and
a sensor mounted to a circuit board of the electronic speed controller and configured to capture data associated with the orientation of the magnet coupled to the shaft of the electric motor, the sensor providing the data to the electronic speed controller via an electrical pathway of the circuit board,
wherein the electronic speed controller is configured to determine a rotational position of the shaft based on the data from the sensor, the electronic speed controller configured to adjust the electrical power provided to the electric motor based at least in part on the rotational position of the shaft.

18. The electric watercraft of claim 17 wherein the electronic speed controller includes a plurality of transistors mounted to a first side of the circuit board, the circuit board including a plurality of thermally conductive vias configured to conduct heat to a second side of the circuit board and away from the plurality of transistors.

19. The electric watercraft of claim 18 wherein the sensor is mounted to the second side of the circuit board.

20. The electric watercraft of claim 18 wherein the circuit board is substantially circular and the plurality of transistors are mounted about the periphery of the circuit board.

21. The electric watercraft of claim 17 wherein the housing includes at least an outer wall, and wherein the electronic speed controller is positioned within the housing such that the plurality of transistors are proximal to an internal surface of the outer wall of the housing.

22. The electric watercraft of claim 21 wherein the housing includes an internal wall and the circuit board is mounted to the internal wall of the housing.

23. The electric watercraft of claim 22 further comprising a thermally conductive pad positioned between the circuit board and the internal wall.

24. The electric watercraft of claim 22 wherein the magnet is coupled to an end portion of the shaft that extends through the internal wall of the housing.

25. The electric watercraft of claim 24 wherein the end portion of the shaft includes a cavity and the magnet is disposed within the cavity.

26. The electric watercraft of claim 17 wherein the shaft is formed of a non-magnetic material.

27. The electric watercraft of claim 21 wherein at least a portion of an external surface of the outer wall of the housing is configured to be in contact with a fluid when the electric watercraft operates within the fluid.

28. The electric watercraft of claim 17 wherein the waterproof propulsion system is mounted adjacent to a trailing edge of the strut.
